(19) United States
(12) Patent Application Publication
(10) Pub. No.: US 2026/0052355 A1
(43) Pub. Date: Feb. 19, 2026

(54) MULTI-STREAM DYNAMIC SPATIAL AUDIO RENDERING

(71) Applicant: QUALCOMM Incorporated, San Diego, CA (US)

(72) Inventors: Graham Bradley DAVIS, Seattle, WA (US); Shankar THAGADUR SHIVAPPA, San Diego, CA (US)

(21) Appl. No.: 19/297,811

(22) Filed: Aug. 12, 2025

Related U.S. Application Data
(60) Provisional application No. 63/684,114, filed on Aug. 16, 2024.

(51) Int. Cl. H04S 7/00; G06F 3/16; H04R 1/10; H04R 3/12; H04R 5/033

(52) U.S. Cl. CPC H04S 7/304; G06F 3/165; H04R 1/1041; H04R 3/12; H04R 5/033; H04R 2420/07; H04R 2499/13; H04S 2400/11; H04S 2420/01

(57) ABSTRACT

A device includes one or more processors configured to obtain an audio stream and to obtain first spatial state data that indicates an estimated first spatial state of a first wearable audio device. The one or more processors are configured to determine a first device identifier that corresponds to the first wearable audio device. The one or more processors are configured, based on the audio stream, to generate a first rendered audio stream associated with the estimated first spatial state and to generate a second rendered audio stream. The one or more processors are configured to output, to the first and second wearable audio devices, the combined audio stream that includes the first rendered audio stream, the first device identifier, and the second rendered audio stream, where the first rendered audio stream is associated with the first device identifier.

### I. CROSS-REFERENCE TO RELATED APPLICATIONS

The present application claims priority from the commonly owned U.S. Provisional Patent Application No. 63/684,114, filed Aug. 16, 2024, entitled “METHOD AND SYSTEM OF MULTI-MODAL TRACKING FOR DYNAMIC SPATIAL AUDIO RENDERING”, the content of which is incorporated herein by reference in its entirety.

### II. FIELD

The present disclosure is generally related to processing and outputting of audio data.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to provide binaural audio that simulates the way humans perceive sound in the real world, changing audio outputs of a user device based on a spatial state of the user device (e.g., headphones) relative to a source device (e.g., a television). For example, if the user is facing the television and then turns to the user's right, audio in headphones of the user will change so that audio in the left ear becomes louder and audio in the right ear becomes softer. Spatial audio rendering systems use position and orientation tracking to adjust binaural audio based on user movements. Some devices support tracking individual user devices in three degrees of freedom (3DoF) and streaming rendered audio using individual communication links and corresponding transmitters.

### IV. SUMMARY

According to one implementation of the present disclosure, a device includes a memory configured to store audio content. The device also includes one or more processors coupled to the memory. The one or more processors are configured to obtain an audio stream. The one or more processors are configured to obtain first spatial state data that indicates an estimated first spatial state of a first wearable audio device of a plurality of wearable audio devices, where the estimated first spatial state includes a first estimated position of the first wearable audio device, a first estimated orientation of the first wearable audio device, or both. The one or more processors are configured to determine a first device identifier that corresponds to the first wearable audio device. The one or more processors are configured to generate, based on the audio stream, a first rendered audio stream associated with the estimated first spatial state. The one or more processors are configured to generate, based on the audio stream, a second rendered audio stream. The one or more processors are configured to generate a combined audio stream corresponding to the plurality of wearable audio devices, where the combined audio stream includes the first rendered audio stream, the first device identifier, and the second rendered audio stream, and where the combined audio stream associates the first rendered audio stream with the first device identifier. The one or more processors are configured to output the combined audio stream to the plurality of wearable audio devices.

According to another implementation of the present disclosure, a method includes obtaining, at one or more processors, an audio stream. The method also includes obtaining, at the one or more processors, first spatial state data that indicates an estimated first spatial state of a first wearable audio device of a plurality of wearable audio devices, where the estimated first spatial state includes a first estimated position of the first wearable audio device, a first estimated orientation of the first wearable audio device, or both. The method also includes determining, at the one or more processors, a first device identifier that corresponds to the first wearable audio device. The method also includes generating, based on the audio stream, a first rendered audio stream associated with the estimated first spatial state. The method also includes generating, based on the audio stream, a second rendered audio stream. The method also includes generating a combined audio stream corresponding to the plurality of wearable audio devices, where the combined audio stream includes the first rendered audio stream, the first device identifier, and the second rendered audio stream, and where the combined audio stream associates the first rendered audio stream with the first device identifier. The method also includes outputting the combined audio stream to the plurality of wearable audio devices.

According to another implementation of the present disclosure, a device includes a memory configured to store audio content. The device also includes one or more processors coupled to the memory. The one or more processors are configured to receive a combined audio stream. The combined audio stream includes a first device identifier, a first rendered audio stream associated with the first device identifier, and a second rendered audio stream, where the first rendered audio stream corresponds to an estimated first spatial state of a first device. The one or more processors are configured to, based on a determination that a local device identifier matches the first device identifier, output audio based on the first rendered audio stream.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative aspect of a system operable to multi-stream audio to a plurality of wearable audio devices, in accordance with some examples of the present disclosure.

FIG. 2 is a diagram of a first illustrative aspect of operations of an audio stream manager of the system of FIG. 1, in accordance with some examples of the present disclosure.

FIG. 3 is a diagram of a second illustrative aspect of operations of an audio stream manager of the system of FIG. 1, in accordance with some examples of the present disclosure.

FIG. 4 illustrates an example packet of a combined audio stream output by a source device of the system of FIG. 1, in accordance with some examples of the present disclosure.

FIG. 5 illustrates a first example of a header of a packet of FIG. 4, in accordance with some examples of the present disclosure.

FIG. 6 illustrates a second example of a header of a packet of FIG. 4, in accordance with some examples of the present disclosure.

FIG. 7 is a block diagram of a particular illustrative aspect of a system operable to receive and process multi-streamed audio output by a source device of the system of FIG. 1, in accordance with some examples of the present disclosure.

FIG. 8 is a diagram of a first illustrative aspect of operations associated with multi-streaming audio to a plurality of wearable audio devices, in accordance with some examples of the present disclosure.

FIG. 9 is a diagram of a second illustrative aspect of operations associated with multi-streaming audio to a plurality of wearable audio devices, in accordance with some examples of the present disclosure.

FIG. 10 is a diagram of a third illustrative aspect of operations associated with multi-streaming audio to a plurality of wearable audio devices, in accordance with some examples of the present disclosure.

FIG. 11 illustrates an example of an integrated circuit operable to multi-stream audio to a plurality of wearable audio devices or to receive and process multi-stream audio, in accordance with some examples of the present disclosure.

FIG. 12 is a diagram of a mobile device operable to multi-stream audio to a plurality of wearable audio devices or to receive and process multi-stream audio, in accordance with some examples of the present disclosure.

FIG. 13 is a diagram of a headset operable to multi-stream audio to a plurality of wearable audio devices or to receive and process multi-stream audio, in accordance with some examples of the present disclosure.

FIG. 14 is a diagram of a wearable electronic device operable to multi-stream audio to a plurality of wearable audio devices or to receive and process multi-stream audio, in accordance with some examples of the present disclosure.

FIG. 15 is a diagram of a voice-controlled speaker system operable to multi-stream audio to a plurality of wearable audio devices, in accordance with some examples of the present disclosure.

FIG. 16 is a diagram of a camera operable to multi-stream audio to a plurality of wearable audio devices or to receive and process multi-stream audio, in accordance with some examples of the present disclosure.

FIG. 17 is a diagram of a headset, such as a virtual reality, mixed reality, or augmented reality headset, operable to multi-stream audio to a plurality of wearable audio devices or to receive and process multi-stream audio, in accordance with some examples of the present disclosure.

FIG. 18 is a diagram of a first example of a vehicle operable to multi-stream audio to a plurality of wearable audio devices, in accordance with some examples of the present disclosure.

FIG. 19 is a diagram of a mixed reality or augmented reality glasses device operable to multi-stream audio to a plurality of wearable audio devices or to receive and process multi-stream audio, in accordance with some examples of the present disclosure.

FIG. 20 is a diagram of earbuds operable to multi-stream audio to a plurality of wearable audio devices or to receive and process multi-stream audio, in accordance with some examples of the present disclosure.

FIG. 21 is a diagram of a second example of a vehicle operable to multi-stream audio to a plurality of wearable audio devices, in accordance with some examples of the present disclosure.

FIG. 22 is a diagram of a particular implementation of a method of multi-streaming audio to a plurality of wearable audio devices that may be performed by a source device of FIG. 1, in accordance with some examples of the present disclosure.

FIG. 23 is a diagram of a particular embodiment of a method of receiving and processing multi-stream audio that may be performed by a wearable audio device of FIG. 1 or FIG. 7, in accordance with some examples of the present disclosure.

FIG. 24 is a block diagram of a particular illustrative example of a device that is operable to multi-stream audio to a plurality of wearable audio devices or to receive and process multi-stream audio, in accordance with some examples of the present disclosure.

### VI. DETAILED DESCRIPTION

In some cases, it is desirable for a source device to multi-stream multiple versions of an audio stream (e.g., where at least one version is a binaural audio stream corresponding to a respective user) to multiple wearable audio devices simultaneously. Multiple versions of an audio stream can typically be output as separate audio streams to corresponding wearable audio devices. The separate audio streams are typically output using respective output devices (e.g., respective transmitters). In some systems, rather than multi-streaming different audio streams simultaneously, because a source device may have or be configured to use a single output device (e.g., a single transmitter), packets corresponding to the different audio streams may be transmitted sequentially in a time-multiplexed manner. The sequential transmission can result in higher latency and reduced transmission efficiency. Further, in some cases, wearable audio devices cannot parse a combined audio stream that includes multiple versions of an audio stream to play a corresponding rendered audio stream.

Systems and methods of multi-streaming audio to a plurality of wearable audio devices are disclosed. For example, an audio stream manager obtains an audio stream and first spatial state data that indicates an estimated spatial state of a first wearable audio device. The audio stream manager determines a first device identifier corresponding to the first wearable audio device. The audio stream manager generates, based on the audio stream, a first rendered audio stream associated with the first wearable audio device. In some embodiments, the first rendered audio stream includes a binaural audio stream corresponding to a first user that is wearing the first wearable audio device. The audio stream manager also generates, based on the audio stream, a second rendered audio stream. In some cases, the second rendered audio stream includes a binaural audio stream corresponding to a second user that is wearing a second wearable audio device. The audio stream manager generates and outputs a combined audio stream that includes the first rendered audio stream, the first device identifier, and the second rendered audio stream, where the first rendered audio stream is associated with the first device identifier. In some cases, the combined audio stream also includes a second device identifier corresponding to the second wearable audio device, where the second rendered audio stream is associated with the second device identifier. In some cases, the second rendered audio stream corresponds to a default audio stream. As a result, the audio stream manager multi-streams audio data as a combined audio stream to the first wearable audio device and to the second wearable audio device using a single output device.

Further, systems and methods of receiving and processing multi-stream audio at a wearable audio device are disclosed. For example, an audio stream handler receives a combined audio stream that includes a first device identifier, a first rendered audio stream associated with the first device identifier, and a second rendered audio stream. Based on a determination that a local device identifier matches the first device identifier, the audio stream handler outputs audio based on the first rendered audio stream. In some cases, the combined audio stream also includes a second device identifier, where the second rendered audio stream is associated with the second device identifier. Based on a determination that the local device identifier does not match the second device identifier, the audio stream handler refrains from outputting audio based on the second rendered audio stream. In some cases, the second rendered audio stream corresponds to a default audio stream and, based on a determination that the local device identifier does not match the first device identifier, the audio stream handler outputs audio based on the second rendered audio stream.

An audio stream manager of a source device thus multi-streams a plurality of audio streams to a plurality of wearable audio devices as a combined audio stream using a single output device, where at least one of the plurality of audio streams is based on an estimated spatial state of a user. An audio stream handler of a wearable audio device thus receives and processes a combined audio stream, identifying and outputting a rendered audio stream corresponding to a user of the wearable audio device.

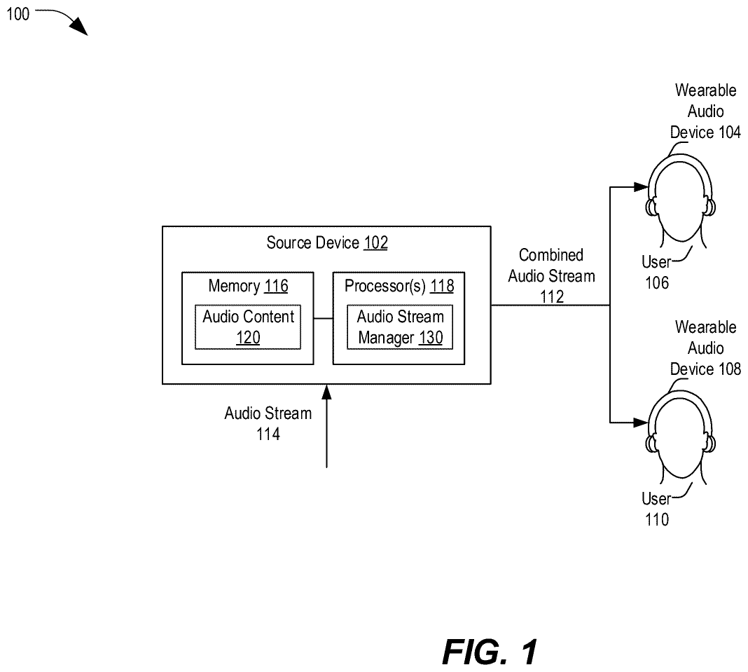

Particular aspects of the present disclosure are described below with reference to the drawings. In the description, common features are designated by common reference numbers. As used herein, various terminology is used for the purpose of describing particular embodiments only and is not intended to be limiting of embodiments. For example, the singular forms “a,” “an,” and “the” are intended to include the plural forms as well, unless the context clearly indicates otherwise. Further, some features described herein are singular in some embodiments and plural in other embodiments. To illustrate, FIG. 1 depicts a source device 102 including one or more processors (“processor(s)” 118 of FIG. 1), which indicates that in some embodiments the source device 102 includes a single processor 118 and in other embodiments the source device 102 includes multiple processors 118. For ease of reference herein, such features are generally introduced as “one or more” features and are subsequently referred to in the singular or optional plural (as indicated by “(s)”) unless aspects related to multiple of the features are being described.

The phrase “corresponds to” as used herein is a relational phrase indicating correspondence, equivalence, or matching. For example, if A corresponds to B, then A is B, there is a mapping between A and B, or A matches B. The phrase “is associated with” as used herein is a broad relational phrase indicating a looser or more general relationship such as, for example, a categorical relationship (e.g., A is part of or belongs to B), a causal relationship (e.g., A causes B), a logical relationship (e.g., If A then B), correlation (e.g., when A is present B is present), a structural relationship (e.g., the B that is coupled to A), and other possible relationships. Correspondence always includes association; whereas association can, but does not always, indicate correspondence. For example, if A is associated with B, there can be a mapping between A and B that could be described as correspondence between A and B.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an embodiment, and/or an aspect, and should not be construed as limiting or as indicating a preference or a preferred embodiment. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some embodiments, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, receiving, or accessing the parameter (or signal) that is already generated, such as by another component or device.

Within this disclosure, in some cases, different entities (which are variously referred to as “components,” “units,” “devices,” etc.) are described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not coupled to it). Thus, an entity described or recited as “configured to” perform some task refers to something physical, such as a device, circuit, memory storing program instructions executable to implement the task, etc. This phrase is not used herein to refer to something intangible. Further, the term “configured to” is not intended to mean “configurable to.” An unprogrammed field-programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Referring to FIG. 1, a particular illustrative aspect of a system 100 configured to multi-stream audio to a plurality of wearable audio devices is disclosed. The system 100 includes a source device 102 that is configured to communicate with one or more wearable audio devices. The system 100 includes a source device 102, a wearable audio device 104 associated with (e.g., worn by) a user 106, and a wearable audio device 108 associated with a user 110. The source device 102 includes one or more processors 118 coupled to a memory 116. The memory 116 is configured to store audio content 120. In the illustrated implementation, the audio stream manager 130 includes at least a portion of one or more pipelines of the one or more processors 118 used to multi-stream the audio.

In the example illustrated in FIG. 1, the system 100 includes a plurality of wearable audio devices, such as the wearable audio device 104 and the wearable audio device 108, within a transmission coverage area of the source device 102 (e.g., a transmitter of the source device 102). One or more wearable audio devices can enter or exit the transmission coverage area of the source device 102 at various times. As used herein, a “wearable audio device” refers to a device that is configured to be worn and includes or is coupled to at least one speaker that is configured to be worn in, around, near, or covering an ear. For example, in various embodiments, “wearable audio device” refers to earbuds, a headset device, a virtual reality headset, a mixed reality headset, an augmented reality headset, a mixed reality glasses device, an augmented reality glasses device, a mobile phone, a tablet computer device, or a camera device.

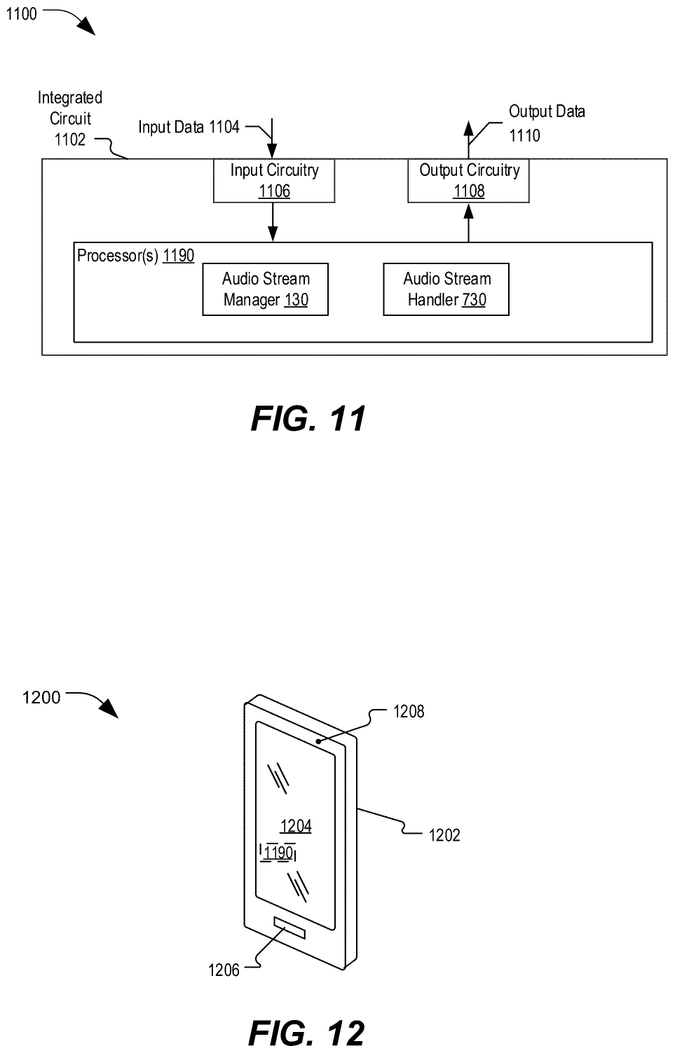

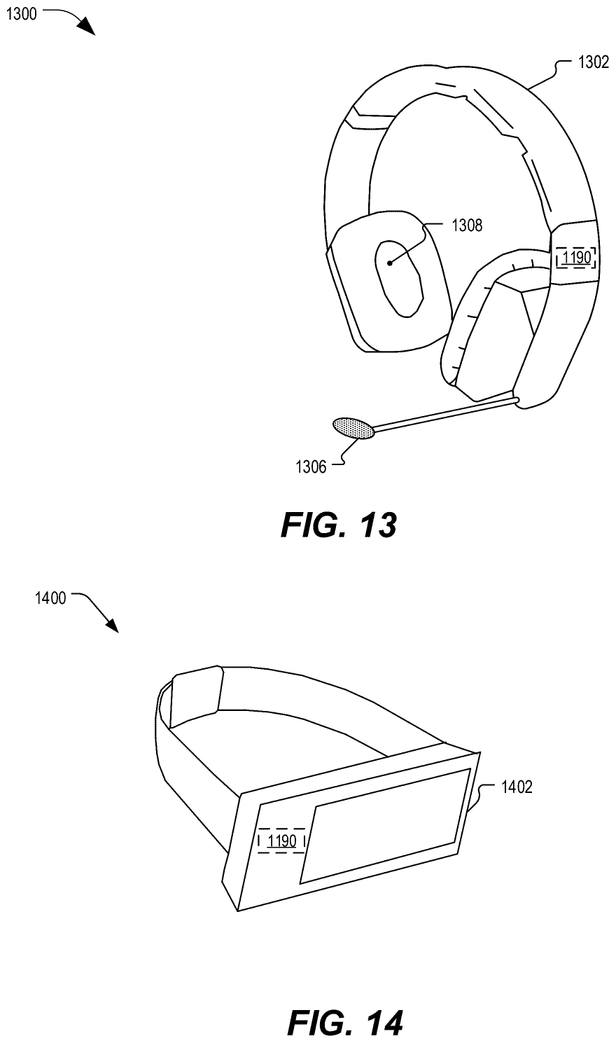

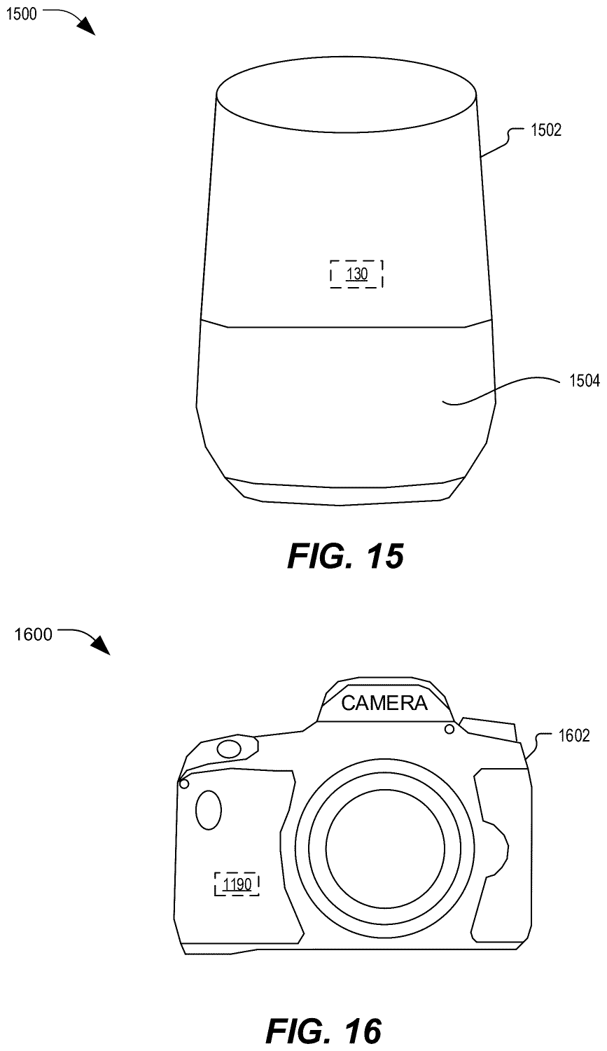

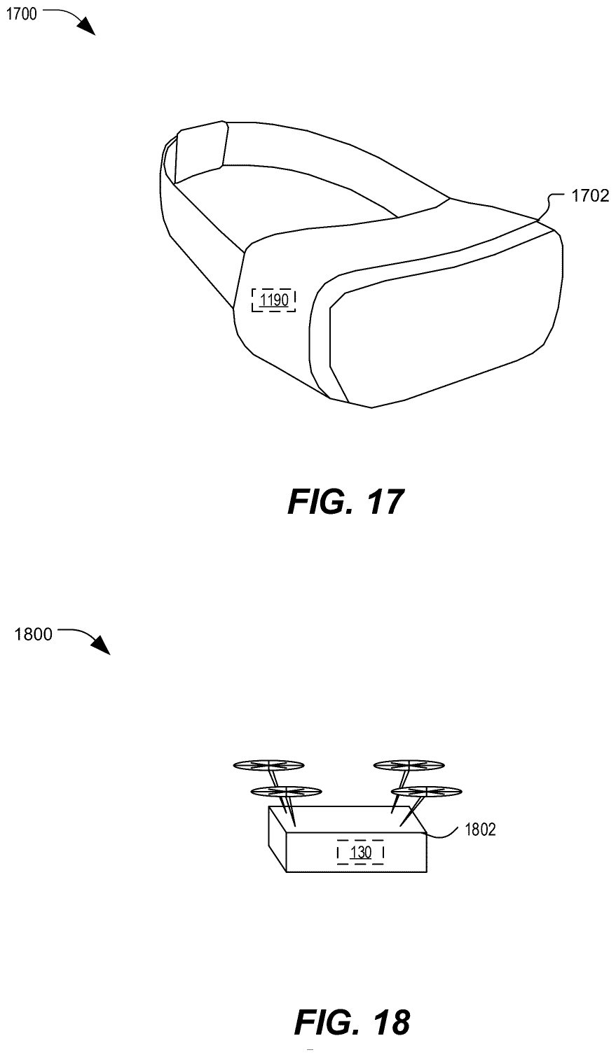

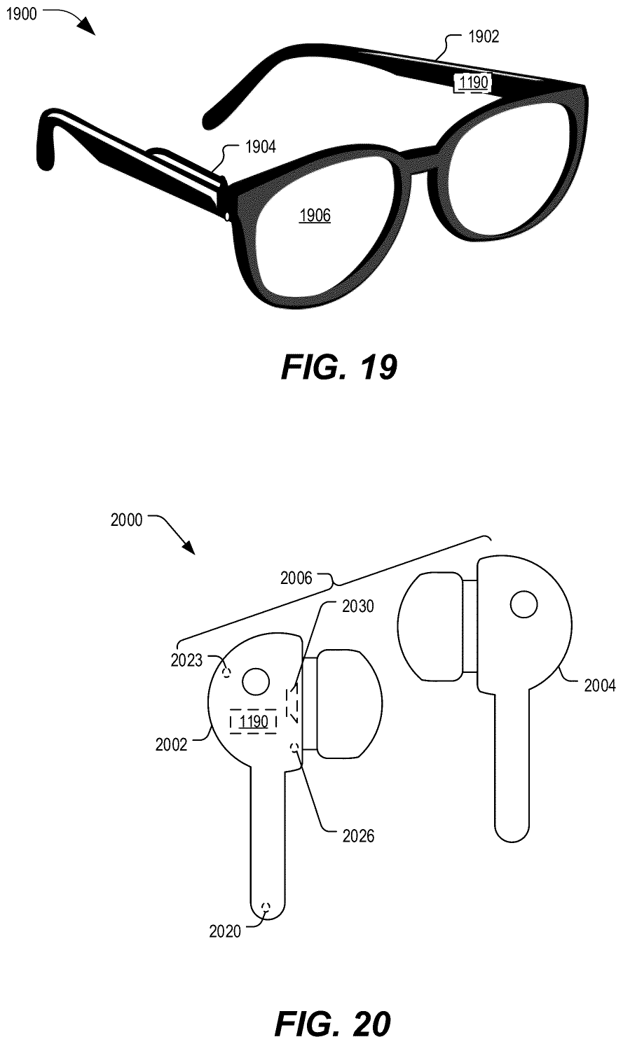

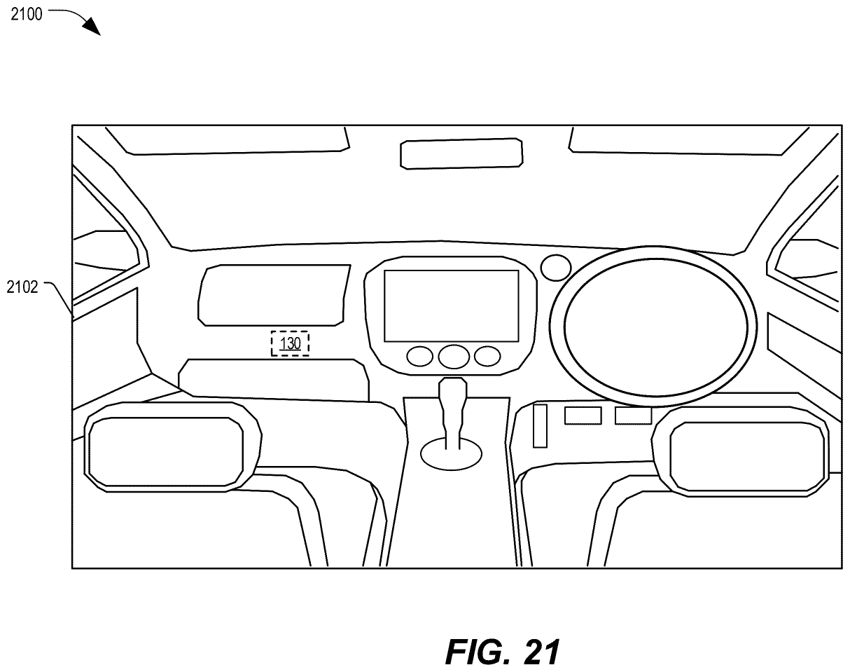

In some embodiments, the source device 102 or components of the source device 102 correspond to or are included in one of various types of devices operable to multi-stream audio to a plurality of wearable audio devices as a component in a system. In an illustrative example, as depicted in FIG. 11, the audio stream manager 130 is integrated in one or more processors of an integrated circuit 1102. In other examples, the integrated circuit 1102, including the audio stream manager 130, is integrated in a mobile phone or tablet as depicted in FIG. 12, a headset as depicted in FIG. 13, a wearable electronic device as depicted in FIG. 14, a camera as depicted in FIG. 16, a virtual reality, mixed reality, or augmented reality headset as depicted in FIG. 17, a mixed reality or augmented reality glasses device, as described with reference to FIG. 19, or earbuds, as described with reference to FIG. 20. In other examples, the audio stream manager 130 is integrated in a voice-controlled speaker system as depicted in FIG. 15, a vehicle as depicted in FIG. 18, or a vehicle as depicted in FIG. 21.

The audio stream manager 130 is configured to generate, based on an audio stream 114, multiple rendered audio streams that include a first rendered audio stream, a second rendered audio stream, and optionally one or more additional rendered audio streams. The audio stream manager 130 is configured to generate a combined audio stream 112 including the multiple rendered audio streams and to transmit (e.g., broadcast) the combined audio stream 112 to any wearable audio devices within a transmission coverage area of the source device 102. The audio stream manager 130 is configured to generate the combined audio stream 112 indicating that at least the first rendered audio stream is associated with at least a particular wearable audio device. For example, the audio stream manager 130 is configured to generate the combined audio stream 112 that includes a first device identifier of the wearable audio device 104 and that indicates that the first rendered audio stream corresponds to the first device identifier. In some embodiments, the audio stream manager 130 is configured to generate the combined audio stream 112 that includes a second device identifier of the wearable audio device 108 and that indicates that the second rendered audio stream corresponds to the second device identifier. In other embodiments, the audio stream manager 130 is optionally configured to generate the combined audio stream 112 that includes the second rendered audio stream as a default audio stream.

The wearable audio devices 104 and 108 are each configured to receive the combined audio stream 112 and to generate audio based on an applicable rendered audio stream from the combined audio stream 112. For example, the wearable audio device 104 is configured to, based on a determination that a local device identifier of the wearable audio device 104 matches the first device identifier, generate audio based on the first rendered audio stream that corresponds to the first device identifier. As another example, the wearable audio device 108 is configured to, based on a determination that a local device identifier of the wearable audio device 108 does not match the first device identifier, refrain from generating audio based on the first rendered audio stream that corresponds to the first device identifier.

In some embodiments, the audio stream manager 130 is configured to generate a combined audio stream that is devoid of a default audio stream. In these embodiments, the wearable audio device 108, based on a determination that the local device identifier of the wearable audio device 108 does not match any device identifier indicated in the combined audio stream 112 as corresponding to a rendered audio stream, refrains from generating audio based on the combined audio stream 112. In some other embodiments, the audio stream manager 130 is configured to generate a combined audio stream that includes a default audio stream and the wearable audio device 108 is configured to selectively extract the default audio stream from a combined audio stream if there is no other rendered audio stream indicated as corresponding to the wearable audio device 108. In these embodiments, the wearable audio device 108 is configured to, based on a determination that a local device identifier of the wearable audio device 108 does not match any device identifier indicated in the combined audio stream 112 as corresponding to a rendered audio stream, generate audio based on the second rendered audio stream that corresponds to a default audio stream.

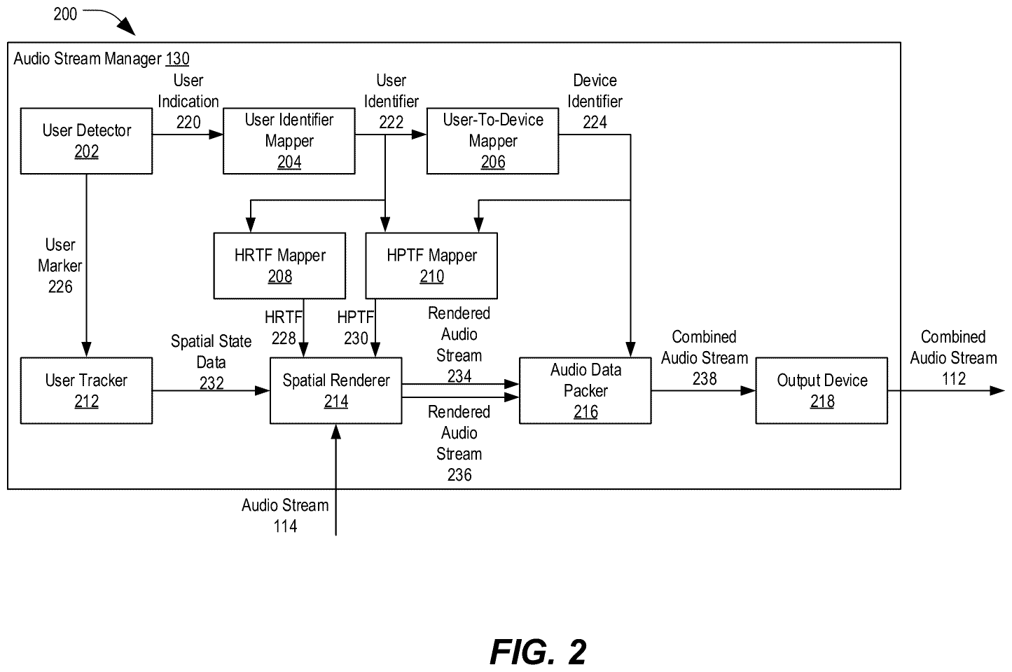

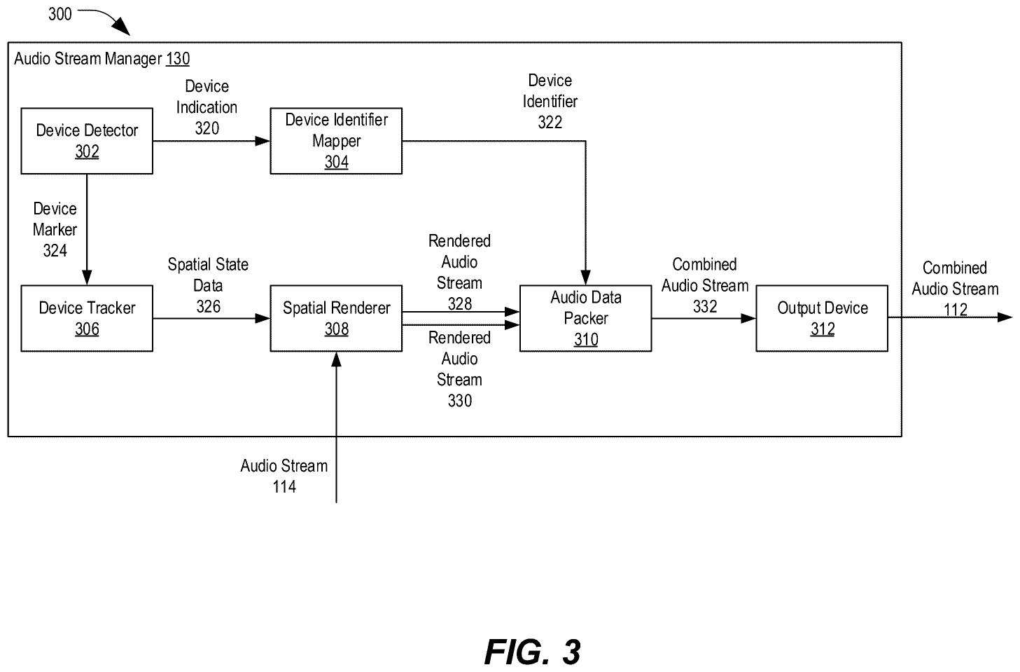

During operation, the audio stream manager 130 obtains an audio stream 114. For example, the audio stream manager 130 can receive the audio stream 114 from the one or more processors 118, a component of the source device 102, the memory 116, a network device, a storage device, or a combination thereof. The audio stream manager 130 generates multiple rendered audio streams based on the audio stream 114, as described herein. In some embodiments, some or all audio data generated based on the audio stream 114 is stored in the memory 116 as audio content 120. As described further with reference to FIGS. 2 and 3, the audio stream manager 130 outputs a combined audio stream 112 that includes at least a first rendered audio stream for the wearable audio device 104, a device identifier corresponding to the wearable audio device 104, and a second rendered audio stream.

The first rendered audio stream is a binaural audio stream generated based on an estimated spatial state of the wearable audio device 104, the user 106, or both. Accordingly, to indicate the association between the first rendered audio stream and the wearable audio device 104, the user 106, or both, the first rendered audio stream is associated with the device identifier corresponding to the wearable audio device 104. In some embodiments, the second rendered audio stream is a binaural audio stream generated based on an estimated spatial state of the wearable audio device 108, the user 110, or both. In those embodiments, in addition to including the device identifier corresponding to the wearable audio device 104, the combined audio stream 112 also includes a device identifier corresponding to the wearable audio device 108. In other embodiments, the second rendered audio stream corresponds to a default audio stream (e.g., a binaural audio stream corresponding to a default spatial state) and is not associated with any particular wearable audio device or user. In those embodiments, the combined audio stream 112 does not include a device identifier corresponding to the wearable audio device 108 (e.g., because the wearable audio device 108 is to play audio corresponding to the default audio stream).

In some embodiments, to generate a rendered binaural audio stream, the source device 102 obtains spatial state data (e.g., an estimated position, an estimated orientation, or both) indicating an estimated spatial state of a corresponding wearable audio device, user, or both. For example, the source device 102 obtains first spatial state data of the wearable audio device 104, the user 106, or both. In some cases, spatial state data includes six degrees of freedom (6DoF) tracking information, combining both position and orientation information. In other cases, the spatial state data includes position-only data or orientation-only data that represents 3DoF information. In some embodiments, position information indicates a physical location (e.g., x, y, and z coordinates) of the corresponding wearable audio device, user, or both. In some embodiments, orientation information includes rotation characteristics (e.g., roll, pitch, and yaw) of the corresponding wearable audio device, user, or both.

A plurality of wearable audio devices, including the wearable audio devices 104 and 108, within a transmission coverage area of the source device 102 receive the combined audio stream 112. Based on determining that a rendered binaural audio stream of the combined audio stream 112 is associated with a local device identifier of the wearable audio device 104 (e.g., by determining that the local device identifier matches the first device identifier of the combined audio stream 112), the wearable audio device 104 outputs audio corresponding to the rendered binaural audio stream to the user 106. In some embodiments, the combined audio stream 112 further includes a rendered binaural audio stream associated with a device identifier of the wearable audio device 108. Based on determining that a rendered binaural audio stream of the combined audio stream 112 is not associated with the local device identifier (e.g., by determining that the local device identifier does not match the second device identifier), the wearable audio device 104 refrains from outputting audio corresponding to the rendered binaural audio stream to the user 106. Optionally, based on determining that none of the streams of the combined audio stream 112 are associated with the local device identifier (e.g., by determining that the local device identifier does not match any device identifier of the combined audio stream 112 or based on an indication in the combined audio stream 112), the wearable audio device 104 refrains from outputting audio based on the combined audio stream 112. In some embodiments, the combined audio stream 112 includes a default audio stream, where the wearable audio device 108 outputs the default audio stream to the user 110 based on determining that a local device identifier of the wearable audio device 108 does not match any device identifiers that are indicated in the combined audio stream 112 as corresponding to a rendered audio stream.

Optionally, in some embodiments, the audio stream manager 130 can transition between a combined stream mode and a single stream mode. In the combined stream mode, the audio stream manager 130 generates and initiates transmission of a combined audio stream. In the single stream mode, the audio stream manager 130 generates and initiates transmission of a single rendered audio stream. As an example, in some embodiments in which the audio stream manager 130 is configured to in the combined stream mode generate and transmit a combined audio stream that includes at least two rendered audio streams, the audio stream manager 130, based on determining that only a single wearable audio device is detected or that all wearable audio devices are to receive a same rendered audio stream, transitions or remains in the single stream mode to generate and transmit a single audio stream. As another example, in some embodiments in which the audio stream manager 130 is configured to in the single stream mode generate and transmit only a single audio stream, the audio stream manager 130, based on detection of a plurality of wearable audio devices that collectively are to receive at least two rendered audio streams, transitions into the combined stream mode to generate and transmit a combined audio stream that includes at least two rendered audio streams.

It should be understood that a count of detected wearable audio devices is provided as an illustrative example of a stream mode criterion used to select a stream mode of the audio stream manager 130. In other examples, the stream mode criterion can be based on a comparison of various factors (e.g., a count of detected users, a remaining battery level, available bandwidth, spatial states of one or more of the detected wearable audio devices, characteristics (e.g., rendered stream isolation capabilities) of one or more of the detected wearable audio devices, or a combination thereof) and respective thresholds. In some examples in which the audio stream manager 130 is in the single stream mode although multiple wearable audio devices are detected, the audio stream manager 130 can, in the single stream mode, transmit a default audio stream or perform sequential transmission of multiple rendered audio streams so that a single audio stream is transmitted at a time.

A technical advantage of the system 100 thus includes multi-streaming audio to a plurality of wearable audio devices using a single combined audio stream. The wearable audio devices 104 and 108 isolate applicable rendered audio streams and output respective audio. As a result, a number of output devices (e.g., transmitters) used to send rendered audio streams to the wearable audio devices 104 and 108 is reduced, as compared to a system that individually streams audio to wearable audio devices using dedicated links. Another technical advantage of the system 100 is combined audio stream transmission can include reduced latency and increased transmission efficiency as compared to sequential transmission of audio streams.

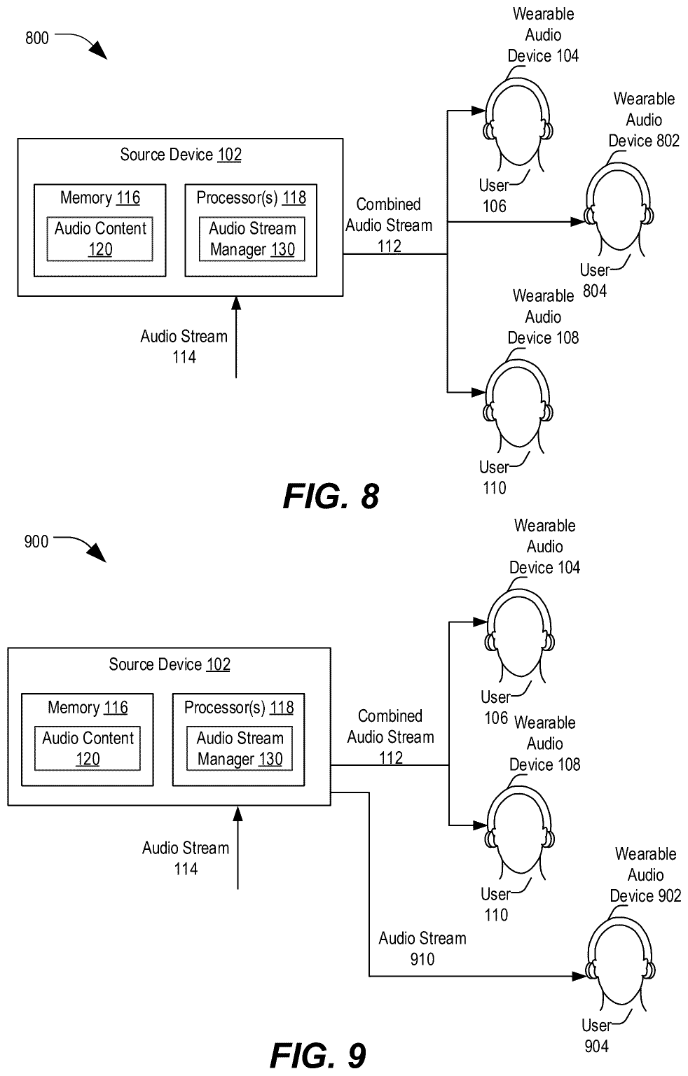

It should be understood that the combined audio stream 112 including two rendered audio streams is provided as an illustrative example. In other examples, the combined audio stream 112 can include more than two rendered audio streams. In an example, the combined audio stream 112 includes at least two rendered audio streams that are each based on an estimated spatial state of a respective user, a respective wearable audio device, or both. In some cases, in addition to at least one rendered audio stream based on a respective estimated spatial state, the combined audio stream 112 optionally includes a default audio stream. As described further with reference to FIGS. 8 and 9, although the system 100 is illustrated as only including the two wearable audio devices 104 and 108 corresponding to the users 106 and 110, respectively, in other embodiments, additional wearable audio devices are considered.

FIGS. 2 and 3 illustrate examples of the audio stream manager 130 of the system 100 of FIG. 1. FIG. 2 illustrates an audio stream manager 130 that renders audio streams based on spatial state data associated with spatial states of users (e.g., the users 106 and 110). FIG. 3 illustrates an audio stream manager 130 that renders audio streams based on spatial state data associated with spatial states of wearable audio devices (e.g., the wearable audio devices 104 and 108).

FIG. 2 is a diagram of an illustrative aspect of operations of an example 200 of the audio stream manager 130 of the system 100 of FIG. 1 associated with multi-streaming audio to a plurality of wearable audio devices, in accordance with some examples of the present disclosure. The audio stream manager 130 includes a user detector 202, a user identifier mapper 204, a user-to-device mapper 206, a head-related transfer function (HRTF) mapper 208, a head-phone transfer function (HPTF) mapper 210, a user tracker 212, a spatial renderer 214, an audio data packer 216, and an output device 218.

As described with reference to FIG. 1, the audio stream manager 130 obtains an audio stream 114 and outputs a combined audio stream 112 that includes at least two rendered audio streams for a plurality of wearable audio devices. At least one rendered audio stream is a binaural audio stream corresponding to a particular wearable audio device, a user wearing the particular wearable audio device, or both. In some cases, a rendered audio stream corresponds to multiple wearable audio devices (e.g., because multiple wearable audio devices have similar spatial state data or because multiple wearable audio devices are to output a default rendered audio stream). In the example 200, the audio stream manager 130 detects and tracks at least one user to generate binaural audio for the at least one user.

The user detector 202 detects a user indication 220 in one or more images of the user (e.g., by analyzing the one or more images of the user) and outputs the user indication 220 to the user identifier mapper 204. For example, a user indication 220 can include or be based on at least a portion of an image. The portion of the image can depict any user identification feature, such as facial features, biometric features, posture, height, build, clothing (e.g., a uniform), an identification card, contextual features (e.g., a person at a particular location at a particular time), an object associated with the user, or a combination thereof. In some examples, the user indication 220 can include or be based on a user identification feature (e.g., gait) that is detectible based on multiple images. In some cases, the user detector 202 detects indications of multiple users and outputs multiple respective user indications. In some embodiments, the user detector 202 is configured to obtain the one or more images from a camera, a memory, a network device, a wearable audio device, another component of or coupled to the source device 102, or a combination thereof.

The user identifier mapper 204 accesses (e.g., includes or retrieves) user mapping data that maps user indications to user identifiers and outputs a determined user identifier to the user-to-device mapper 206. For example, the user identifier mapper 204, based on a determination that the user mapping data maps the user indication 220 (e.g., facial features) to a user identifier 222 of a user, outputs the user identifier 222 to the user-to-device mapper 206. Optionally, as part of a configuration phase, the user identifier mapper 204 updates the user mapping data. In some examples, the user identifier mapper 204 updates the user mapping data to indicate that one or more user indications map to a user identifier of a user. To illustrate, the user identifier mapper 204 can update the user mapping data based on receiving a user input indicating that the one or more user indications and the user identifier are associated with the same user.

The user-to-device mapper 206 accesses (e.g., includes or retrieves) device mapping data that maps user identifiers to device identifiers of associated wearable audio devices and outputs a device identifier that matches a user identifier to the audio data packer 216. For example, the user-to-device mapper 206, based on a determination that the device mapping data maps the user identifier 222 of a user to a device identifier 224 of a wearable audio device that is associated with the user, outputs the device identifier 224 to the audio data packer 216. In some embodiments, the device identifier 224 includes a Media Access Control (MAC) address of a wearable audio device, an internet protocol (IP) address of the wearable audio device, or both. Optionally, as part of a configuration phase, the user-to-device mapper 206 updates the device mapping data. In some examples, the user-to-device mapper 206 updates the device mapping data to indicate that a user identifier of a user maps to a wearable audio device based on a determination that the wearable audio device was most recently used by the user, is registered to the user, or both.

The user detector 202, concurrently or sequentially with detecting the user indication 220, generates a user marker 226 based on the one or more images of the user. The user detector 202 outputs the user marker 226 to the user tracker 212 concurrently or sequentially with outputting the user indication 220 to the user identifier mapper 204. In some cases, the user detector 202 detects user markers of multiple users and outputs multiple respective user markers. In some embodiments, the user marker 226 is the same as the user indication 220. For example, in some cases, the user marker 226 and the user indication 220 both include cropped images of at least one user identification feature of a user. In some embodiments, the user marker 226 provided to the user tracker 212 for spatial state estimation is distinct from the user indication 220 provided to the user identifier mapper 204 for user identification. For example, in some cases, the user marker 226 indicates sets of facial landmarks of the user and the user indication 220 includes facial encodings of the user. In an illustrative example, the user marker 226 can indicate relative positions of the eyes, nose, and a mouth that can be used to estimate an orientation of a user's head, whereas the user indication 220 can indicate eye shape, eye color, nose shape, and mouth shape as well as the relative positions of the eyes, nose, and mouth that can be used to differentiate one user from another.

The user tracker 212 generates, based on the user marker 226, spatial state data 232 indicating an estimated spatial state of a user and outputs the spatial state data 232 to the spatial renderer 214. In various embodiments, the spatial state data includes a first estimated position of the user, a first estimated orientation of the user, or both. In some cases, the spatial state data indicates a first estimated position of a wearable audio device, a first estimated orientation of the wearable audio device, or both. For example, in some embodiments, the user tracker 212 includes a Computer Vision (CV) system that detects positions and orientations of a user based on the user marker 226.

The spatial renderer 214 generates at least two rendered audio streams (e.g., rendered audio streams 234 and 236) for a plurality of wearable audio devices based on spatial state data (e.g., the spatial state data 232) and based on the audio stream 114. In some cases, each rendered audio stream is based on respective spatial state data. In some cases, each rendered audio stream corresponds to a respective wearable audio device of the plurality of wearable audio devices. For example, the spatial renderer 214 generates a rendered audio stream 234 based on the spatial state data 232 corresponding to a first user and the audio stream 114 and generates a rendered audio stream 236 based on the spatial state data corresponding to a second user and the audio stream 114. To illustrate, the spatial renderer 214 renders, based on a first spatial state indicated by the spatial state data 232 of the first user, the audio stream 114 to generate the rendered audio stream 234 to preserve a spatial consistency for the first user even as the first user changes positions, orientations, or both. As a result, the rendered audio stream 234 includes binaural audio associated with the first user. Similarly, in some examples, the spatial renderer 214 renders, based on a second spatial state indicated by the spatial state data of the second user, the audio stream 114 to generate the rendered audio stream 236 to preserve a spatial consistency for the second user even as the second user changes positions, orientations, or both. As a result, in some examples, the rendered audio stream 236 includes binaural audio associated with the second user. Optionally, in some embodiments, the spatial renderer 214 generates at least two rendered audio streams in the combined stream mode or renders a single audio stream in the single stream mode, as described with reference to FIG. 1. In an example, the spatial renderer 214 is configured to transition between the combined stream mode and the single stream mode based on various criteria, as described with reference to FIG. 1.

In some cases, one of the rendered audio streams (e.g., the rendered audio stream 236) is a default audio stream that does not include binaural modifications to the audio stream or that includes a set of binaural modifications based on a spatial state of the audio stream manager 130, a default spatial state (e.g., a default position, a default orientation, or both) of a representative user, or both. The spatial renderer 214 sends the rendered audio streams 234 and 236 to the audio data packer 216. In some cases, the spatial renderer generates more than two rendered audio streams and sends the generated rendered audio streams to the audio data packer 216. The audio data packer 216 combines the rendered audio streams 234 and 236 into a single combined audio stream 238, where one rendered audio stream (e.g., the rendered audio stream 234) of the combined audio stream 238 is associated with the device identifier 224. In cases where the audio data packer 216 receives a number of device identifiers corresponding to the number of rendered audio streams, each rendered audio stream is associated with a respective one of the device identifiers. The audio data packer 216 outputs the combined audio stream 238 to the output device 218.

In some embodiments, the user indication 220 indicates an association with the user marker 226. In some embodiments, the user marker 226 indicates an association with the user indication 220. To illustrate, a user indication 220 and a user marker 226 that are generated from the same image portion (e.g., a cropped image) are associated with each other. In some embodiments, the user detector 202 can include the same tag (e.g., a sequence number) in or along with each of the user indication 220 and the user marker 226 that are generated based on the same image portion to indicate an association.

In an example, each of the user indication 220 and the user marker 226 that is generated from a first image portion depicting at least one identifiable feature of a first user (e.g., the user 106 of FIG. 1) includes a first tag that indicates an association between the user indication 220 and the user marker 226. One or more components of the audio stream manager 130 generate output data based on input data and copy a tag (e.g., the first tag) from the input data to the output data to enable identification of related data. For example, the user identifier mapper 204 generates the user identifier 222 (e.g., of the user 106) based on the user indication 220 and includes the first tag of the user indication 220 in the user identifier 222. The user-to-device mapper 206 generates the device identifier 224 of a first wearable audio device (e.g., of the wearable audio device 104) based on the user identifier 222 and includes the first tag of the user identifier 222 in the device identifier 224. The user tracker 212 generates the spatial state data 232 based on the user marker 226 and includes the first tag of the user marker 226 into the spatial state data 232. The spatial renderer 214 renders the audio stream 114 based on the spatial state data 232 and includes the first tag of the spatial state data 232 in the rendered audio stream 234. In some cases, the rendered audio stream 236 corresponds to a default audio stream that is not associated with any tag.

The audio data packer 216, based on a determination that each of the device identifier 224 and the rendered audio stream 234 are associated with the first tag, generates the combined audio stream 238 that associates (e.g., indicates a connection between) the device identifier 224 (e.g., of the wearable audio device 104) and the rendered audio stream 234 (e.g., that is based on an estimated spatial state of the user 106). In some examples, the first tag is not included in the combined audio stream 238. In some cases, the audio data packer 216, based on a determination that the rendered audio stream 236 is not associated with any tag, generates the combined audio stream 238 indicating that the rendered audio stream 236 corresponds to a default audio stream that is not associated with any device identifier. The combined audio stream 112 includes the device identifier 224, the rendered audio stream 234, and the rendered audio stream 236. The audio data packer 216 provides the combined audio stream 238 to the output device 218.

In some cases, the user detector 202 generates a user indication and a user marker based on a second image portion that depicts at least one identifiable feature of a second user (e.g., the user 110 of FIG. 1). The user detector 202 generates each of the user indication and the user marker including a second tag. In these cases, the spatial renderer 214 renders the audio stream 114 based on spatial state data (e.g., indicating a spatial state of the user 110) to generate the rendered audio stream 236 and includes the second tag from the spatial state data in the rendered audio stream 236. Similarly, the user-to-device mapper 206 generates a device identifier (e.g., of the wearable audio device 108 of FIG. 1) based on a user identifier of the second user and includes the second tag from the user identifier to the device identifier. The audio data packer 216, based on a determination that each of the device identifier (e.g., of the wearable audio device 108) and the rendered audio stream 236 (e.g., that is based on the estimated spatial state of the user 110) include or are associated with the second tag, generates the combined audio stream 238 that associates the device identifier (e.g., of the wearable audio device 108) and the rendered audio stream 236. In some examples, the second tag is not included in the combined audio stream 238. The combined audio stream 112 includes the device identifier of the first wearable audio device (e.g., the wearable audio device 104), the rendered audio stream 234, the device identifier of the second wearable audio device (e.g., the wearable audio device 108), and the rendered audio stream 236. The combined audio stream 112 indicates that the device identifier 224 of the first wearable audio device (e.g., the wearable audio device 104) corresponds to the rendered audio stream 234 and that the device identifier of the second wearable audio device (e.g., the wearable audio device 108) corresponds to the rendered audio stream 236. The audio data packer 216 provides the combined audio stream 238 to the output device 218.

The output device 218 outputs the combined audio stream 238 as the combined audio stream 112 to the wearable audio devices. In some embodiments, the output device 218 includes a transmitter that broadcasts the combined audio stream 112. In some embodiments, the output device 218 includes a modem that sends the combined audio stream 112 to the wearable audio devices over a communication network (e.g., the Internet or a Personal Area Network such as a Local Area Network using a Wireless Fidelity (Wi-Fi) audio system or a Bluetooth® (a registered trademark of the Bluetooth Special Interest Group, Inc.) radio system). In some embodiments, the output device 218 includes a binary unit system (BUS) configured to output the combined audio stream 112.

Optionally, in some embodiments, the audio stream manager 130 includes the HRTF mapper 208. In some examples, the HRTF mapper 208 has access to user-to-HRTF data. In these examples, the HRTF mapper 208 receives the user identifier 222 and determines that the user-to-HRTF data includes a HRTF 228 indicative of user characteristics (e.g., facial landmarks, latent space facial characteristics, preferred equalization settings, hearing loss compensation settings, spatial enhancements, etc.) corresponding to the user identifier 222. The HRTF mapper 208 sends the HRTF 228 to the spatial renderer 214, which renders a corresponding audio stream (e.g., the rendered audio stream 234) based on the HRTF 228.

In some cases, the HRTF 228 is generated by a HRTF personalization procedure (e.g., a photogrammetry-based HRTF estimation). In some cases, the HRTF 228 is a default HRTF or is based on a “closest match” stored HRTF to characteristics identified by the user detector 202. For example, the HRTF mapper 208 includes or has access to characteristic-to-HRTF mapping data that indicates mappings between sets of characteristics to corresponding HRTFs. In this example, the HRTF mapper 208, based on a determination that a set of characteristics detected by the user detector 202 is a closest match to a first set of characteristics of the characteristic-to-HRTF mapping data and that the first set of characteristics maps to the HRTF 228, sends the HRTF 228 to the spatial renderer 214. The spatial renderer 214 renders a corresponding audio stream (e.g., the rendered audio stream 234) based on the HRTF 228. In some examples, each of the HRTF 228 and the rendered audio stream includes the same tag included in the user identifier 222.

Optionally, in some embodiments, the audio stream manager 130 includes the HPTF mapper 210. The HPTF mapper 210 receives the user identifier 222 and the device identifier 224 and determines a HPTF 230 to be used as a compensation filter during rendering. The HPTF 230 is based on an acoustic coupling of a device to a user's car/ear canal, and thus the HPTF 230 may differ based on user characteristics, device characteristics, or both. In some embodiments, the HPTF 230 includes or has access to HPTF mapping data. In some examples, the HPTF mapping data maps pairs of user identifiers and device identifiers to HPTFs. In these examples, the HPTF mapper 210 selects the HPTF 230 based on a determination that the HPTF mapping data indicates that the user identifier 222 and the device identifier 224 map to the HPTF 230. In some other examples, the HPTF mapping data maps user characteristics and device characteristics to HPTFs. In these examples, the HPTF mapper 210 selects the HPTF 230 based on determining that the HPTF mapping data indicates that user characteristics received from the user detector 202 and device characteristics received from the user-to-device mapper 206 are a closest match to a set of characteristics that map to the HPTF 230. The HPTF mapper 210 sends the HPTF 230 to the spatial renderer 214, which renders a corresponding audio stream (e.g., the rendered audio stream 234) based on the HPTF 230. In some cases, the HPTF 230 is a default HPTF or is based on a default filter for the device (e.g., an average of other users' HPTFs or determined based upon the HPTFs of other users identified as having similar facial characteristics) or is based on a default filter for the user (e.g., an HPTF for a similar device). In some examples, each of the HPTF 230 and the rendered audio stream includes the same tag included in the user identifier 222. Optionally, in some embodiments, the spatial renderer 214 renders the audio stream 114 based on the spatial state data 232 of a user and optionally based on the HRTF 228, the HPTF 230, or both, to generate the rendered audio stream 234.

As further discussed with reference to FIG. 8, in some cases, the audio stream manager 130 identifies that a plurality of users have matching spatial states (e.g., have spatial state data having values that are within a threshold of each other). In some embodiments, rather than generate separate rendered audio for each user of the plurality of users, the audio stream manager 130 generates a single rendered audio stream associated with each of the plurality of users. Accordingly, device identifiers corresponding to each of the wearable audio devices of the plurality of users are associated with the rendered audio stream. As a result, in some cases, multiple users can be associated with a same rendered audio stream that includes binaural audio data.

Accordingly, in the example 200, the audio stream manager 130 determines spatial states of one or more users, identifies wearable audio devices associated with the users, and provides respective rendered binaural audio streams to a plurality of wearable audio devices. Optionally, in some examples, at least one of the rendered audio streams can correspond to a default audio stream that is independent of a detected spatial state of a user, although the default audio stream can optionally be based on a default spatial state. The respective rendered audio streams are output as a single combined audio stream 112. As a result, a technical advantage of the audio stream manager 130 is that the audio stream manager 130 can output multiple rendered audio streams using a single output device 218.

FIG. 3 is a diagram of an illustrative aspect of operations of an example 300 of the audio stream manager 130 of the system 100 of FIG. 1 associated with multi-streaming audio to a plurality of wearable audio devices, in accordance with some examples of the present disclosure. The audio stream manager 130 includes a device detector 302, a device identifier mapper 304, a device tracker 306, a spatial renderer 308, an audio data packer 310, and an output device 312.

As described with reference to FIG. 1, the audio stream manager 130 obtains an audio stream 114 and outputs a combined audio stream 112 that includes at least two rendered audio streams for a plurality of wearable audio devices. At least one rendered audio stream is a binaural audio stream corresponding to a particular wearable audio device, a user wearing the particular wearable audio device, or both. In some cases, a rendered audio stream corresponds to multiple wearable audio devices (e.g., because multiple wearable audio devices have similar spatial state data or because multiple wearable audio devices are to output a default rendered audio stream). In the example 300, the audio stream manager 130 detects and tracks at least one wearable audio device to generate binaural audio for the at least one user.

The device detector 302 detects device indication 320 in one or more images of a wearable audio device (e.g., by analyzing the one or more images of the wearable audio device) and outputs the device indication 320 to the device identifier mapper 304. For example, a device indication 320 can include or be based on a portion of an image. The portion of the image can depict any device identification feature, such as physical features (e.g., shape, size, color), identifying marks (e.g., a quick response (QR) code printed on the wearable audio device), contextual features (e.g., a wearable audio device at a particular location at a particular time), an object associated with the wearable audio device (e.g., an external speaker), or a combination thereof. In some cases, the device detector 302 detects the wearable audio device based on a communication received from the wearable audio device (e.g., a registration communication). In some cases, the device detector 302 detects indications of multiple wearable audio devices and outputs multiple respective device indications. In some embodiments, the device detector 302 is configured to obtain the one or more images from a camera, a memory a network device, a wearable audio device, another component of or coupled to the source device 102, or a combination thereof.

The device identifier mapper 304 accesses (e.g., includes or receives) device mapping data that maps device indications to device identifiers and outputs a determined device identifier to the audio data packer 310. For example, the device identifier mapper, based on a determination that the device mapping data maps the device indication 320 (e.g., a QR code printed on the wearable audio device) to a device identifier 322 of a wearable audio device, outputs the device identifier 322 to the audio data packer 310. In some embodiments, the device identifier 322 includes a MAC address of a wearable audio device, an IP address of the wearable audio device, or both. Optionally, as part of a configuration phase, the device identifier mapper 304 updates the device mapping data. In some examples, the device identifier mapper 304 updates the device mapping data to indicate that one or more device indications map to a device identifier of a wearable audio device. To illustrate, the device identifier mapper 304 can update the device mapping data based on receiving a device input indicating that the one or more device indications and the device identifier are associated with the same wearable audio device. In some embodiments, the device identifier 322 is similar to (e.g., includes, is the same as, or indicates) the device identifier 224 of FIG. 2.

The device detector 302, concurrently or sequentially with detecting the device indication 320, generates a device marker 324 based on the one or more images of the wearable audio device. The device detector 302 outputs the device marker 324 to the device tracker 306 concurrently or sequentially with outputting the device indication 320 to the device identifier mapper 304. In some cases, the device detector 302 detects device markers of multiple wearable audio devices and outputs multiple respective device markers. In some embodiments, the device marker 324 is the same as the device indication 320. For example, in some cases, the device marker 324 and the device indication 320 both include cropped images of at least one device indication feature of a wearable audio device. In some embodiments, the device marker 324 provided to the device tracker 306 for spatial state estimation is distinct from the device indication 320 provided to the device identifier mapper 304 for device identification. For example, in some cases, the device marker 324 indicates sets of physical features of the wearable audio device that can be used to estimate an orientation of the wearable audio device and the device indication 320 includes a QR code printed on the wearable audio device that can be used to identify the wearable audio device.

The device tracker 306 generates, based on receiving the device marker 324, spatial state data 326 indicating an estimated spatial state of a wearable audio device and outputs the spatial state data 326 to the spatial renderer 308. In various embodiments, the spatial state data includes a first estimated position of the wearable audio device, a first estimated orientation of the wearable audio device, or both. For example, in some embodiments, the device tracker 306 includes a CV system that determines estimated positions and orientations of a wearable audio device based on the device marker 324. As another example, the device tracker 306 determines estimated positions and orientations of wearable audio devices based on a combination of at least sensor data and tracked position data of the wearable audio devices. The device tracker 306 sends the spatial state data 326 to the spatial renderer 308.

The spatial renderer 308 generates at least two rendered audio streams (e.g., rendered audio streams 328 and 330) for a plurality of wearable audio devices based on spatial state data (e.g., the spatial state data 326) and based on the audio stream 114. In some cases, each rendered audio stream is based on respective spatial state data. In some cases, each rendered audio stream corresponds to a respective wearable audio device of the plurality of wearable audio devices. For example, the spatial renderer 308 generates a rendered audio stream 328 based on the spatial state data 326 corresponding to a first wearable audio device and the audio stream 114 and generates a rendered audio stream 330 based on the spatial state data corresponding to a second wearable audio device and the audio stream 114. To illustrate, the spatial renderer 308 renders, based on a first spatial state indicated by the spatial state data 326 of the first wearable audio device, the audio stream 114 to generate the rendered audio stream 328 to preserve a spatial consistency for the first wearable audio device even as a first user associated with the first wearable audio device changes positions, orientations, or both. As a result, the rendered audio stream 328 includes binaural audio associated with the first wearable audio device. Similarly, in some examples, the spatial renderer 308 renders, based on a second spatial state indicated by the spatial state data of the second wearable audio device, the audio stream 114 to generate the rendered audio stream 330 to preserve a spatial consistency for the second wearable audio device even as a second user associated with the second wearable audio device changes positions, orientations, or both. As a result, in some examples, the rendered audio stream 330 includes binaural audio associated with the second wearable audio device.

In some cases, one of the rendered audio streams (e.g., the rendered audio stream 330) is a default audio stream that does not include binaural modifications to the audio stream or that includes a set of binaural modifications based on a spatial state of the audio stream manager 130, a default spatial state (e.g., a default position, a default orientation, or both) of a representative wearable audio device, or both. The spatial renderer 308 sends the rendered audio streams 328 and 330 to the audio data packer 310. In some cases, the spatial renderer generates more than two rendered audio streams and sends the generated rendered audio streams to the audio data packer 310. In some embodiments, the spatial renderer 308 is configured to perform one or more similar operations as the spatial renderer 214 of FIG. 2.

The audio data packer 310 combines the rendered audio streams 328 and 330 into a single combined audio stream 332, where one rendered audio stream (e.g., the rendered audio stream 328) of the combined audio stream 332 is associated with the device identifier 322. In cases where the audio data packer 310 receives a number of device identifiers corresponding to the number of rendered audio streams, each rendered audio stream is associated with a respective one of the device identifiers. The audio data packer 310 outputs the combined audio stream 332 to the output device 312. In some embodiments, the audio data packer 310 is configured to perform one or more similar operations as the audio data packer 216 of FIG. 2.

In an example, each of the device indication 320 and the device marker 324 that is generated from a first image portion depicting at least one identifiable feature of a first wearable audio device (e.g., the wearable audio device 104 of FIG. 1) includes a first tag that indicates an association between the device indication 320 and the device marker 324. One or more components of the audio stream manager 130 generate output data based on input data and copy a tag (e.g., the first tag) from the input data to the output data to enable identification of related data. For example, the device identifier mapper 304 generates the device identifier 322 (e.g., of the wearable audio device 108) based on the device indication 320 and includes the first tag of the device indication 320 in the device identifier 322. The device tracker 306 generates the spatial state data 326 based on the device marker 324 and includes the first tag of the device marker 324 into the spatial state data 326. The spatial renderer 308 renders the audio stream 114 based on the spatial state data 326 and includes the first tag of the spatial state data 326 in the rendered audio stream 328. In some cases, the rendered audio stream 330 corresponds to a default audio stream that is not associated with any tag.

The audio data packer 310, based on a determination that each of the device identifier 322 and the rendered audio stream 328 are associated with the first tag, generates the combined audio stream 332 that associates the device identifier 322 (e.g., of the wearable audio device 104) and the rendered audio stream 328 (e.g., that is based on an estimated spatial state of the wearable audio device 104). In some examples, the first tag is not included in the combined audio stream 332. In some cases, the audio data packer 310, based on a determination that the rendered audio stream 330 is not associated with any tag, generates the combined audio stream 332 indicating that the rendered audio stream 330 corresponds to a default audio stream that is not associated with any device identifier. The combined audio stream 112 includes the device identifier 322, the rendered audio stream 328, and the rendered audio stream 330. The audio data packer 310 provides the combined audio stream 332 to the output device 312.

In some cases, the device detector 302 generates a device indication and a device marker based on a second image portion that depicts at least one identifiable feature of a second wearable audio device (e.g., the wearable audio device 108 of FIG. 1). The device detector 302 generates each of the device indication and the device marker including a second tag. In these cases, the spatial renderer 308 renders the audio stream 114 based on spatial state data (e.g., indicating a spatial state of the wearable audio device 108) to generate the rendered audio stream 330 and includes the second tag from the spatial state data in the rendered audio stream 330. The audio data packer 310, based on a determination that each of the device identifier (e.g., of the wearable audio device 108) and the rendered audio stream 330 (e.g., that is based on the estimated spatial state of the wearable audio device 108) include or are associated with the second tag, generates the combined audio stream 332 that associates the device identifier (e.g., of the wearable audio device 108) and the rendered audio stream 330. In some examples, the second tag is not included in the combined audio stream 332. The combined audio stream 112 includes the device identifier 322 of the first wearable audio device (e.g., the wearable audio device 104), the rendered audio stream 328, the device identifier of the second wearable audio device (e.g., the wearable audio device 108), and the rendered audio stream 330. The combined audio stream 112 indicates that the device identifier 322 of the first wearable audio device (e.g., the wearable audio device 104) corresponds to the rendered audio stream 328 and that the device identifier of the second wearable audio device (e.g., the wearable audio device 108) corresponds to the rendered audio stream 330. The audio data packer 310 provides the combined audio stream 332 to the output device 312.

The output device 312 outputs the combined audio stream 332 as the combined audio stream 112 to the wearable audio devices. In some embodiments, the output device 312 includes a transmitter that broadcasts the combined audio stream 112. In some embodiments, the output device 312 includes a modem that sends the combined audio stream 112 to the wearable audio devices over a communication network (e.g., the Internet or a Personal Area Network such as a Local Area Network using a Wi-Fi audio system or a Bluetooth radio system). In some embodiments, the output device 312 includes a BUS configured to output the combined audio stream 112. In some embodiments, the output device 312 is configured to perform one or more similar operations as the output device 218 of FIG. 2.

As further discussed with reference to FIG. 8, in some cases, the audio stream manager 130 identifies that a plurality of wearable audio devices have matching spatial states (e.g., have spatial state data having values that are within a threshold of each other). In some embodiments, rather than generate separate rendered audio for each wearable audio device of the plurality of wearable audio devices, the audio stream manager 130 generates a single rendered audio stream associated with each of the wearable audio devices of the plurality of wearable audio devices. Accordingly, device identifiers corresponding to each of the wearable audio devices of the plurality of wearable devices are associated with the rendered audio stream. As a result, in some cases, multiple wearable audio devices can be associated with a same rendered audio stream that includes binaural audio data.

Accordingly, in the example 300, the audio stream manager 130 determines spatial states of one or more wearable audio devices and provides respective rendered binaural audio streams to a plurality of wearable audio devices. The respective rendered audio streams are output as a single combined audio stream 112. As a result, a technical advantage of the audio stream manager 130 is that the audio stream manager 130 can output multiple rendered audio streams using a single output device 312. In some examples, at least one of the rendered audio streams can correspond to a default audio stream that is independent of a detected spatial state of a wearable audio device, although the default audio stream can optionally be based on a default spatial state. Another technical advantage of the audio stream manager 130 of FIG. 3 includes the ability to provide the rendered audio streams to the wearable audio devices independently of any prior association (e.g., registration) of a wearable audio device to a particular user.

In some embodiments, spatial state data is associated with both spatial states of users and spatial states of wearable audio devices. Accordingly, in some embodiments, the audio stream manager 130 is configured to perform one or more operations described with reference to FIG. 2, one or more operations described with reference to FIG. 3, or a combination thereof. Further, in some embodiments, the audio stream manager 130 includes one or more components described with reference to FIG. 2, FIG. 3, or both. In some embodiments, the audio stream manager 130 of FIG. 2 includes one or more components that are distinct from one or more components included in the audio stream manager 130 of FIG. 3. For example, optionally, the audio stream manager 130 of FIG. 2 includes a user detector 202 of FIG. 2 that can be excluded from the audio stream manager 130 of FIG. 3 in some embodiments. As another example, in some embodiments, the audio stream manager 130 of FIG. 3 includes a device detector 302 that can be excluded from the audio stream manager 130 of FIG. 2. In some embodiments, an audio stream manager 130 can include one or more of the components described with reference to FIG. 2 in addition to one or more of the components described with reference to FIG. 3. For example, optionally in some embodiments, the audio stream manager 130 can include the user detector 202 and a user tracker 212 described with reference to FIG. 2 and the device detector 302 and a device tracker 306 described with reference to FIG. 3. In these embodiments, a spatial renderer of the audio stream manager 130 (e.g., the spatial renderer 214, the spatial renderer 308, or a combination thereof), based on the spatial state data 232 and the spatial state data 326 (and optionally the HRTF 228, the HPTF 230, or both), renders the audio stream 114 to generate one or more rendered audio streams. In some examples, an output device 218 of FIG. 2 corresponds to (e.g., includes or is the same as) an output device 312 of FIG. 3.

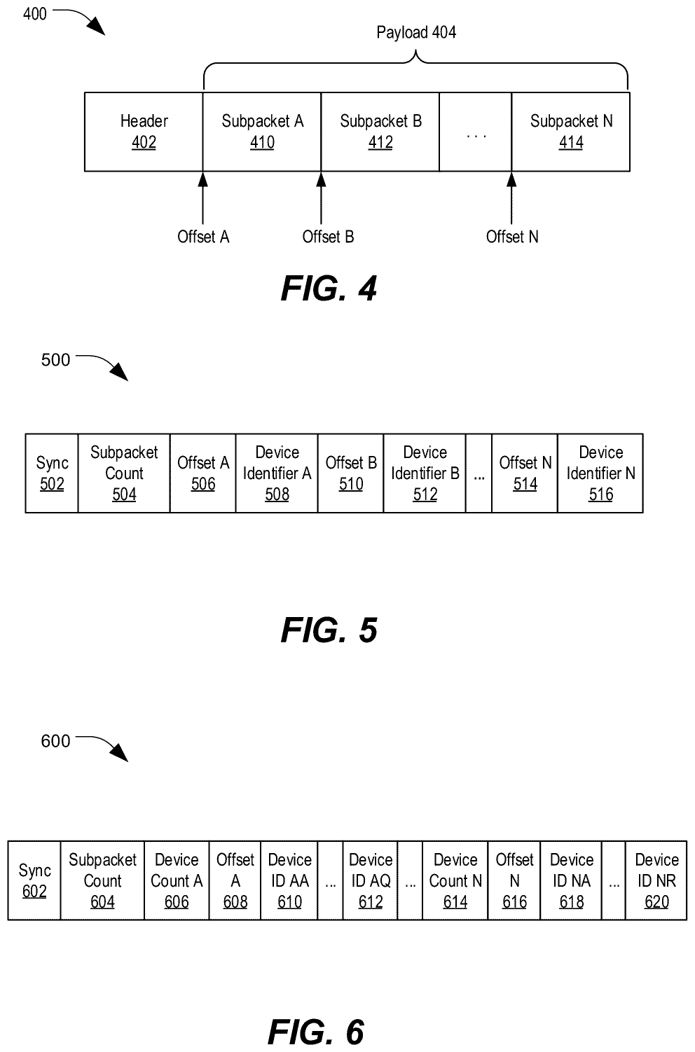

FIG. 4 illustrates an example packet 400 of a combined audio stream 112 output by an audio stream manager 130 of FIGS. 1-3, in accordance with some examples of the present disclosure. The packet 400 includes a header 402 and a payload 404.

As further described with reference to FIGS. 5 and 6, the header 402 includes at least a synchronization indication, a subpacket count that indicates a count of subpackets in the payload 404, and at least one device identifier that indicates at least one wearable audio device associated with a subpacket included in the payload 404 of the packet 400. In some cases, the header 402 includes a plurality of device identifiers that indicate a plurality of wearable audio devices associated with subpackets of the packet 400.

The payload 404 includes a plurality of subpackets at various offsets, including a subpacket A 410 at an offset A, a subpacket B 412 at an offset B, a subpacket N 414 at an offset N, one or more additional subpackets at respective offsets in the payload 404, or a combination thereof. It should be understood that the payload 404 is depicted as including three subpackets as an illustrative example. In other examples, the payload 404 can include fewer than three or more than three subpackets. At least two subpackets of the payload 404 (e.g., the subpacket A 410 and the subpacket B 412) correspond to different rendered audio streams. In some embodiments, each subpacket corresponds to a different rendered audio stream.

Accordingly, the packet 400 includes portions of multiple rendered audio streams. As a result, a single combined audio stream 112 of FIG. 1 includes multiple rendered audio streams. As a result, a technical advantage of the packet 400 is enabling a single output device to output the combined audio stream 112 in the same packet.

FIG. 5 illustrates an example header 500 of the packet 400 of FIG. 4. The header 500 corresponds to the header 402 of FIG. 4. The header 500 includes a synchronization indication 502 and a subpacket count 504. The header 500 further includes a plurality of offset values and a plurality of corresponding device identifiers. In the illustrated embodiment, the header 500 includes an offset A value 506, a device identifier A 508, an offset B value 510, a device identifier B 512, and an offset N value 514 and a device identifier N 516.

In an example, the synchronization indication 502 indicates a beginning of the header 500. The subpacket count 504 indicates a count of the subpackets included in the payload 404 of the packet 400. The offset values (e.g., the offset A value 506, the offset B value 510, and the offset N value 514) indicate respective locations (e.g., beginning offsets) of corresponding subpackets in the payload 404. A device identifier following an offset value indicates a wearable audio device that is associated with a rendered audio stream of a subpacket starting at an offset corresponding to the offset value. For example, the offset B value 510 indicates that a subpacket B 412 of FIG. 4 is located at (e.g., starts from) the offset B in the payload 404. The device identifier B 512, which follows the offset B value 510, indicates that the subpacket B 412 corresponds to a rendered audio stream that is associated with a wearable audio device having a local device identifier matching a device identifier indicated by the device identifier B 512.

Although the offset values in the illustrated embodiment indicate respective beginning offsets, in other embodiments, other addresses are considered, such as respective ending offsets of corresponding subpackets. Although the device identifiers are interleaved with the offsets in the illustrated embodiment, in other embodiments, other organizations are contemplated, such as a count of offsets associated with each device identifier followed by a list of device identifiers or device identifiers preceding the respective offsets. In some embodiments, only a first packet of a group of packets includes device identifiers and subsequent packets in the group include subpackets in the same order so wearable audio devices can identify which subpacket to play based on the first packet.

In some examples, each subpacket is associated with a distinct wearable audio device. To illustrate, in these examples, each offset value of the packet indicates an offset of a distinct subpacket, and each of the device identifiers of the packet matches a local device identifier of a distinct wearable audio device.

In some examples, the payload 404 can include a subpacket (e.g., the subpacket N 414) that is not associated with any wearable audio device. In these examples, the header 500 can include an offset value (e.g., the offset N value 514) that is designated as a default offset value and is not associated with any device identifier. In examples in which the offset N value 514 corresponds to the default offset value, the device identifier N 516 can be excluded from the header 500. It should be understood that a last (e.g., Nth) offset value of the header 500 corresponding to the default offset value is provided as an illustrative example; in other examples, another offset value can be designated as the default offset value.

As a result, a technical advantage of the header 500 is enabling indication of one or more device identifiers and associated subpackets of rendered audio streams of a combined audio stream.

FIG. 6 illustrates an example header 600 of the packet 400 of FIG. 4. The header 600 corresponds to the header 402 of FIG. 4. The header 600 includes a synchronization indication 602 and a subpacket count 604. The header 600 further includes a plurality of device counts, a plurality of offset values, and a plurality of corresponding device identifiers. In the illustrated embodiment, the header 600 includes a device count A 606, an offset A value 608, a device identifier AA 610, a device identifier AQ 612, a device count N 614, an offset N value 616, a device identifier NA 618, and a device identifier NR 620. It should be understood that the header 600 including 2 device counts, 2 offset values, and 4 device identifiers is provided as an illustrative example; in other examples, the header 600 can include more than 2 device counts, more than 2 offset values, fewer than 4 or more than 4 device identifiers, or a combination thereof.

In the example of FIG. 6, a first plurality of wearable audio devices (e.g., a first group of wearable audio devices) are associated with a first rendered audio stream (e.g., because multiple wearable audio devices have similar spatial state data). Further, a second plurality of wearable audio devices (e.g., a second group of wearable audio devices) are associated with a second rendered audio stream. In some cases, a count of devices of the first plurality (e.g., the device count A 606) differs from a count of devices of the second plurality (e.g., the device count N 614). It should be understood that multiple wearable audio devices associated with each of the first rendered audio stream and the second rendered audio stream are provided as an illustrative example. In some other examples, a single wearable audio device can be associated with the first rendered audio stream or a single wearable audio device can be associated with the second rendered audio stream.

In an example, the synchronization indication 602 indicates a beginning of the header 600. The subpacket count 604 indicates a count of the subpackets included in the payload 404 of the packet 400. The offset values (e.g., the offset A value 608 and the offset N value 616) indicate respective locations (e.g., beginning offsets) of corresponding subpackets in the payload 404. The device counts (e.g., the device count A 606 and the device count N 614) indicate counts of devices associated with the rendered audio streams of the subpackets starting at corresponding offset values. The one or more device identifiers following an offset value indicate one or more wearable audio devices that are associated with a rendered audio stream of a subpacket starting at an offset indicated by the offset value. For example, the offset A value 608 indicates the offset A to indicate that a subpacket A 410 of FIG. 4 is located at the offset A in the payload 404. The device identifier AA 610 and the device identifier AQ 612 (e.g., a first group of device identifiers), which follow the offset A value 608, indicate that the subpacket A 410 corresponds to a rendered audio stream that is associated with a first wearable audio device having a local device identifier matching the device identifier AA 610 and a second wearable audio device having a local device identifier matching the device identifier AQ 612. As another example, the offset N value 616 indicates the offset N to indicate that a subpacket N 414 of FIG. 4 is located at the offset N in the payload 404. The device identifier NA 618 and the device identifier NR 620 (e.g., a second group of device identifiers), which follow the offset N value 616, indicate that the subpacket N 414 corresponds to a rendered audio stream that is associated with a third wearable audio device having a local device identifier matching the device identifier NA 618 and a fourth wearable audio device having a local device identifier matching the device identifier NR 620.

Although the offset values in the illustrated embodiment indicate respective beginning offsets, in other embodiments, other addresses are considered, such as respective ending offsets of corresponding subpackets. Although each offset value is depicted between a corresponding device count and corresponding one or more device identifiers in the illustrated embodiment, in other embodiments, other organizations are contemplated, such as device identifiers preceding the respective offsets or a list of device identifiers at the end of the header 600, where the device count A 606 indicates a count of a first plurality of device identifiers of the list that are associated with an offset indicated by the offset A value 608, the device count N 614 indicates a count of a second plurality of device identifiers of the list that are associated with an offset indicated by the offset N value 616, and so on. In some embodiments, only a first packet of a group of packets includes device identifiers and subsequent packets in the group include subpackets in the same order so wearable audio devices can identify which subpacket to play based on the first packet.

In some examples, the header 600 can include a default offset value that is not associated with any device identifier or any device count. In examples in which the offset N value 616 corresponds to the default offset value, the device count N 614 and the one or more device identifiers following the offset N value 616 can be excluded from the header 600. In some aspects, the offset N value 616 in the header 600 can be empty (e.g., set to a default value, such as 0) to indicate the packet 400 does not include a default audio stream. It should be understood that a last (e.g., Nth) offset value of the header 600 corresponding to the default offset value is provided as an illustrative example; in other examples, another offset value can be designated as the default offset value.

As a result, a technical advantage of the header 600 is enabling indication of one or more device identifiers associated with the same subpacket of a rendered audio stream of a combined audio stream.

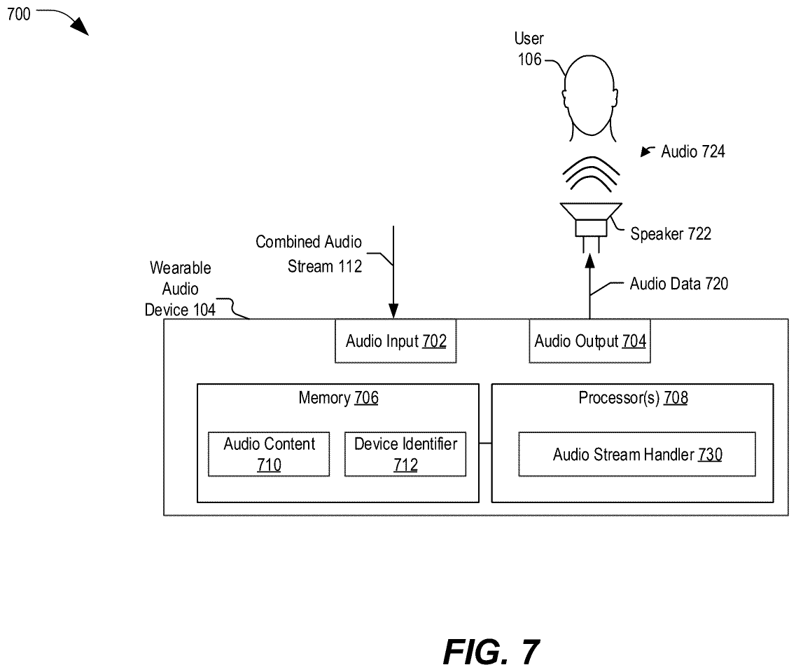

FIG. 7 is a diagram of a particular illustrative aspect of a system 700 configured to receive and process multi-stream audio output by the source device 102 of the system 100 of FIG. 1. The system 700 includes a wearable audio device 104 associated with (e.g., worn by) a user 106. The wearable audio device 104 includes an audio input 702, an audio output 704, a memory 706, and one or more processors 708. The memory 706 is configured to store audio content 710 and a device identifier 712 (e.g., a local device identifier). The one or more processors 708 include an audio stream handler 730. In the illustrated embodiment, the audio stream handler 730 includes at least a portion of one or more pipelines of the one or more processors 708 used to receive and output audio data. In some embodiments, the wearable audio device 104 includes a speaker 722. In other embodiments, the speaker 722 is external to and coupled to the wearable audio device.

In some embodiments, the wearable audio device 104 or components of the wearable audio device 104 correspond to or are included in one of various types of devices operable to receive and process multi-stream audio as a component in a system. In an illustrative example, as depicted in FIG. 11, the audio stream handler 730 is integrated in one or more processors of an integrated circuit 1102. In other examples, the integrated circuit 1102, including the audio stream handler 730, is integrated in a mobile phone or tablet as depicted in FIG. 12, a headset as depicted in FIG. 13, a wearable electronic device as depicted in FIG. 14, a camera as depicted in FIG. 16, a virtual reality, mixed reality, or augmented reality headset as depicted in FIG. 17, a mixed reality or augmented reality glasses device, as described with reference to FIG. 19, or earbuds, as described with reference to FIG. 20.

In the example illustrated in FIG. 7, the system 700 depicts the wearable audio device 104 of FIG. 1. The wearable audio device 104, when within a transmission coverage area of the source device 102 (e.g., a transmitter of the source device 102), is configured to receive the combined audio stream 112 as one or more packets at the audio input 702 and to forward the combined audio stream 112 to the memory 706 for storage and to the audio stream handler 730 for processing. As described above, the combined audio stream 112 includes at least a first device identifier (e.g., the device identifier A 508 of FIG. 5), a first rendered audio stream associated with the first device identifier (e.g., the rendered audio stream of subpacket A 410 of FIG. 4), and a second rendered audio stream (e.g., the rendered audio stream of subpacket B 412 of FIG. 4).

In some embodiments, the audio input 702 includes one or more BUS interfaces to enable the combined audio stream 112 to be received for processing. In some embodiments, the audio output 704 includes one or more BUS interfaces to enable sending of an output signal, such as the audio data 720. In some cases, prior to outputting the audio data 720, other operations are performed on the corresponding rendered audio stream (e.g., decode operations or additional rendering operations).

The audio stream handler 730 is configured to isolate an applicable rendered audio stream of the combined audio stream 112 to output via the speaker 722 to the user 106 by comparing the device identifiers indicated in the combined audio stream 112 to the local device identifier 712 (e.g., a MAC address or an IP address of the wearable audio device 104). Based on determining that the local device identifier 712 matches a device identifier indicated in the combined audio stream 112, the audio stream handler 730 outputs a corresponding rendered audio stream via the audio output 704 as the audio data 720 to the speaker 722. The speaker 722 outputs audio 724 based on the audio data 720. For example, based on a determination that the device identifier 712 matches a first device identifier, audio 724 based on a first rendered audio stream associated with the first device identifier is output via the audio output 704 and the speaker 722.

In some embodiments, based on a determination that the device identifier 712 does not match a particular device identifier indicated in the combined audio stream 112, the audio stream handler 730 refrains from outputting audio based on a rendered audio stream in the combined audio stream 112 that is associated with the particular device identifier. For example, based on a determination that the device identifier 712 does not match a second device identifier indicated in the combined audio stream 112, the audio stream handler 750 refrains from generating and outputting audio based on a second rendered audio stream associated with the second device identifier in the combined audio stream 112.

In various embodiments, various operations are performed based on a determination that the device identifier 712 does not match any device identifiers indicated in the combined audio stream 112. Optionally, in some embodiments, the audio stream handler 730, based on determining that the device identifier 712 does not match any device identifiers indicated in the combined audio stream 112, refrains from outputting audio based on the combined audio stream 112. Optionally, in some embodiments, the audio stream handler 730, based on determining that the device identifier 712 does not match any device identifiers indicated in the combined audio stream 112, outputs a default rendered audio stream included in the combined audio stream 112. In some aspects, the wearable audio device 108 may include one or more similar components and may perform one or more similar operations as described with reference to the wearable audio device 104.

Accordingly, the system 700 is configured to isolate an applicable rendered audio stream from a combined audio stream 112. A technical advantage of the system 700 is that the wearable audio device 104 can output audio that is rendered based on a spatial state of the wearable audio device 104 with reduced (e.g., no) latency associated with receiving multiple rendered audio streams because the multiple rendered audio streams are received as a combined audio stream as compared to separate audio streams. Another technical advantage of some embodiments is that the wearable audio device 104 can output default audio if a combined audio stream does not include audio rendered based on the spatial state of the wearable audio device 104.

Optionally, the audio stream handler 730 is configured to send capability data to the source device 102 during a registration phase indicating that the wearable audio device 104 is configured to process a combined audio stream or is not configured to process a combined audio stream. The source device 102 can send a combined audio stream or a separate audio stream based on the capability data, as further described with reference to FIG. 9.

FIGS. 8-10 illustrate several circumstances that may occur when multi-streaming audio to a plurality of wearable audio devices, in accordance with some examples of the present disclosure.

In an example 800 of FIG. 8, a user 804 wearing a wearable audio device 802 is added to the system 100 of FIG. 1. The audio stream manager 130 sends the combined audio stream 112 to the wearable audio device 104, the wearable audio device 108, and the wearable audio device 802. In the example 800, the user 802 has similar spatial state data to the user 106, the wearable audio device 802 has similar spatial state data to the wearable audio device 104, or both. As a result, the audio stream manager 130, based on a determination that an estimated spatial state of the wearable audio device 802 (or the user 804) matches an estimate spatial state of the wearable audio device 104 (or the user 106), associates both the wearable audio device 104 and the wearable audio device 802 with a single rendered audio stream. For example, the header 600 of FIG. 6 includes device identifiers indicating device identifiers of the wearable audio devices 104 and 802 as corresponding to the offset A value 608 that indicates the offset A of the subpacket A 410. Each of the wearable audio devices 104 and 802 outputs audio based on the subpacket A 410 of FIG. 4. The header 600 includes a device identifier indicating a device identifier of the wearable audio device 108 as corresponding to an offset value indicating the offset B of the subpacket B 412. The wearable audio device 108 outputs audio based on the subpacket B 412 of FIG. 4.

In an example 900 of FIG. 9, a user 904 wearing a wearable audio device 902 is added to the system 100 of FIG. 1. The audio stream manager 130 determines that the wearable audio device 902 is not configured to process the combined audio stream 112 (e.g., because the wearable audio device 902 lacks an audio stream handler, because the wearable audio device 902 is a legacy device, or because the wearable audio device 902 is conserving resources). In some embodiments, the audio stream manager 130 receives capability data from the wearable audio device 902 during a registration phase and determines that the capability data indicates that the wearable audio device 902 is not configured to process a combined audio stream.

Based on the determination, the source device 102 generates and outputs an audio stream 910 to the wearable audio device 902 using a communication link. In an example, the communication link is formed using an IP address of the wearable audio device 902. The audio stream 910 includes a rendered audio stream generated in accordance with the processes discussed with reference to FIGS. 1-3. In some embodiments, the rendered audio stream is associated with a spatial state of the wearable audio device 902, a spatial state of the user 904, or both. In some embodiments, the rendered audio stream is not included in the combined audio stream 112. In other embodiments, the rendered audio stream is included as a default audio stream in the combined audio stream 112 or as a rendered audio stream associated with another wearable audio device in the combined audio stream 112, as described with reference to FIG. 8.

As a result, a technical advantage of the source device 102 of the example 900 includes an ability to stream audio data to the wearable audio device 902 despite the wearable audio device 902 not being configured to process the combined audio stream 112.

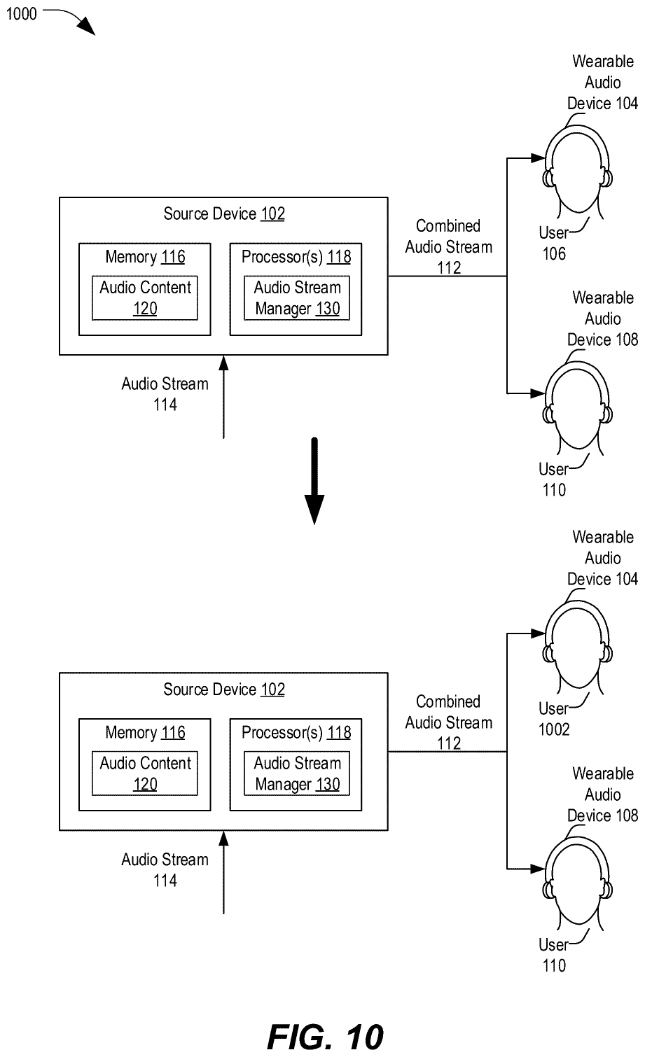

In an example 1000 of FIG. 10, the wearable audio device 104 is passed from the user 106 to a user 1002. In some embodiments, the audio stream manager 130 detects that the user 1002 is using the wearable audio device 104 and associates the user 1002 with a device identifier corresponding to the wearable audio device 104. The audio stream manager 130 renders the audio stream 114 based on an estimated spatial state of the wearable audio device 104, an estimated spatial state of the user 1002, an HRTF 228 associated with the user 1002, an HPTF 230 associated with the user 1002 and the wearable audio device 104, or a combination thereof, to generate a first rendered audio stream (e.g., an updated audio stream), as described with reference to FIGS. 1-3. The audio stream manager 130 generates one or more packets of the combined audio stream 112 that include at least the first rendered audio stream and a device identifier of the wearable audio device 104 and that indicate that the device identifier is associated with the first rendered audio stream, as described with reference to FIGS. 1-6.

A technical advantage of the source device 102 of the example 1000 includes updating a rendered audio stream in a combined audio stream based on detecting that a user of a wearable audio device has changed. Accordingly, the system 100 multi-streams audio to a plurality of wearable audio devices under various circumstances.

FIG. 11 depicts an embodiment 1100 of the source device 102, a wearable audio device 104, or both as an integrated circuit 1102 that includes one or more processors 1190. The one or more processors 1190 include the audio stream manager 130, the audio stream handler 730, or both. In a particular aspect, the one or more processors 1190 include the one or more processors 118 of FIG. 1, the one or more processors 708 of FIG. 7, or a combination thereof. The integrated circuit 1102 also includes input circuitry 1106, such as one or more bus interfaces, to enable input data 1104 to be received for processing. The integrated circuit 1102 also includes output circuitry 1108, such as a bus interface, to enable sending of output data 1110, such as the combined audio stream 112 or the audio data 720. The integrated circuit 1102 enables embodiment of a circuit operable to multi-stream audio to a plurality of wearable audio devices or to receive and process multi-stream audio as a component in a system, such as a mobile phone or tablet as depicted in FIG. 12, a headset as depicted in FIG. 13, a wearable electronic device as depicted in FIG. 14, a voice-controlled speaker system as depicted in FIG. 15, a camera as depicted in FIG. 16, a virtual reality, mixed reality, or augmented reality headset as depicted in FIG. 17, a vehicle as depicted in FIG. 18, a mixed reality or augmented reality glasses device, as described with reference to FIG. 19, earbuds, as described with reference to FIG. 20, or a vehicle as depicted in FIG. 21.

FIG. 12 depicts an embodiment 1200 in which a mobile device 1202 corresponds to (e.g., includes) the source device 102, the wearable audio device 104, or both. In a particular aspect, the mobile device 1202 includes a phone or tablet, as illustrative, non-limiting examples. The mobile device 1202 includes a first microphone 1206, multiple second microphones 1208, and a display screen 1204. Components of the one or more processors 1190 are integrated in the mobile device 1202 and are illustrated using dashed lines to indicate internal components that are not generally visible to a user of the mobile device 1202. In a particular example, the one or more processors 1190 transmit first multi-stream audio as a source device to a plurality of wearable audio devices, receive and process second multi-stream audio from a source device (e.g., another device), or both.

FIG. 13 depicts an embodiment 1300 in which a headset device 1302 corresponds to (e.g., includes) the source device 102, the wearable audio device 104, or both. The headset device 1302 includes a microphone 1306 and a speaker 1308. Components of the one or more processors 1190 are integrated in the headset device 1302 and are illustrated using dashed lines to indicate internal components that are not generally visible to a user of the headset device 1302. In a particular example, the one or more processors 1190 transmit first multi-stream audio as a source device to a plurality of wearable audio devices, receive and process second multi-stream audio from a source device (e.g., another device), or both.

FIG. 14 depicts an embodiment 1400 in which a wearable electronic device 1402, illustrated as a “smart watch,” corresponds to (e.g., includes) the source device 102, the wearable audio device 104, or both. Components of the one or more processors 1190 are integrated in the wearable electronic device 1402 and are illustrated using dashed lines to indicate internal components that are not generally visible to a user of the wearable electronic device 1402. In a particular example, the one or more processors 1190 transmit first multi-stream audio as a source device to a plurality of wearable audio devices, receive and process second multi-stream audio from a source device (e.g., another device), or both.

FIG. 15 is an embodiment 1500 in which a wireless speaker and voice activated device 1502 corresponds to (e.g., includes) the source device 102. The wireless speaker and voice activated device 1502 can have wireless network connectivity and is configured to execute an assistant operation. Components of the one or more processors 1190 are integrated in the voice activated device 1502 and are illustrated using dashed lines to indicate internal components that are not generally visible to a user of the voice activated device 1502. The wireless speaker and voice activated device 1502 also includes a speaker 1504. During operation, the audio stream manager 130 multi-streams audio data as a source device to a plurality of wearable audio devices.

FIG. 16 depicts an embodiment 1600 in which a portable electronic device that corresponds to a camera device 1602. The camera device 1602 corresponds to (e.g., includes) the source device 102, the wearable audio device 104, or both. Components of the one or more processors 1190 are integrated in the camera device 1602 and are illustrated using dashed lines to indicate internal components that are not generally visible to a user of the camera device 1602. In a particular example, the one or more processors 1190 transmit first multi-stream audio as a source device to a plurality of wearable audio devices, receive and process second multi-stream audio from a source device (e.g., another device), or both.

FIG. 17 depicts an embodiment 1700 in which a portable electronic device that corresponds to a virtual reality, mixed reality, or augmented reality headset 1702. The headset 170 corresponds to (e.g., includes), the source device 102, the wearable audio device 104, or both. Components of the one or more processors 1190 are integrated in the headset 1702 and are illustrated using dashed lines to indicate internal components that are not generally visible to a user of the headset 1702. In a particular aspect the one or more processors 1190 transmit first multi-stream audio as a source device to a plurality of wearable audio devices, receive and process second multi-stream audio from a source device, or both.

FIG. 18 depicts an embodiment 1800 in which a vehicle 1802, illustrated as a manned or unmanned aerial device (e.g., a package delivery drone), corresponds to (e.g., includes) the audio stream manager 130. Components of the audio stream manager 130 are integrated in the vehicle 1802 and are illustrated using dashed lines to indicate internal components that are not generally visible to a user of the vehicle 1802. During operation, the audio stream manager 130 multi-streams audio data as a source device to a plurality of wearable audio devices.

FIG. 19 depicts an embodiment 1900 in which a portable electronic device that corresponds to augmented reality or mixed reality glasses 1902 corresponds to (e.g., includes) the source device 102, the wearable audio device 104, or both. The glasses 1902 include a holographic projection unit 1904 configured to project visual data onto a surface of a lens 1906 or to reflect the visual data off of a surface of the lens 1906 and onto the wearer's retina. Components of the one or more processors 1190 are integrated in the glasses 1902 and are illustrated using dashed lines to indicate internal components that are not generally visible to a user of the glasses 1902. The one or more processors 1190 transmit first multi-stream audio data as a source device to a plurality of wearable audio devices, receive and process second multi-stream audio from a source device (e.g., another device), or both.

FIG. 20 depicts an embodiment of earbuds 2000 operable to transmit first multi-stream audio as a source device to a plurality of wearable audio devices, receive and process second multi-stream audio from a source device (e.g., another device), or both, in accordance with some examples of the present disclosure. The earbuds 2000 include a first earbud 2002 and a second earbud 2004, which can also be referred to as an earbud pair 2006. Although earbuds are described, it should be understood that the present technology can be applied to other in-ear or over-ear playback devices. Although two earbuds (e.g., the first earbud 2002 and the second earbud 2004) are shown in FIG. 20, in other examples, the aspects described herein may be integrated into a single earbud.

The first earbud 2002 includes a first microphone 2020, such as a high signal-to-noise microphone positioned to capture the voice of a wearer of the first earbud 2002, an array of one or more other microphones configured to detect ambient sounds and spatially distributed to support beamforming, illustrated as microphone 2023, an “inner” microphone 2024 proximate to the wearer's ear canal (e.g., to assist with active noise cancelling), and a self-speech microphone 2026, such as a bone conduction microphone configured to convert sound vibrations of the wearer's ear bone or skull into an audio signal. The first earbud 2002 also includes one or more speakers 2030. The second earbud 2004 can be configured in a substantially similar manner as the first earbud 2002. In some embodiments, the first earbud 2002 is configured to receive one or more audio signals generated by one or more microphones of the second earbud 2004, such as via wireless transmission between the earbuds 2002 and 2004, or via wired transmission in embodiments in which the earbuds 2002 and 2004 are coupled via a transmission line.

In FIG. 20, the one or more processors 1190 are integrated in the earbuds 2000 and are illustrated using dashed lines to indicate internal components that are not generally visible to a user of the earbuds 2000. For example, a first processor, the processor 1190, may be integrated in the first earbud 2002, and a second processor, which may be similar to the processor 1190, may be integrated in the second earbud 2004. In a particular example, the one or more processors 1190 are operable to transmit first multi-stream audio data as a source device to a plurality of wearable audio devices, receive and process second multi-stream audio from a source device.

FIG. 21 depicts another embodiment 2100 in which a vehicle 2102, illustrated as a car, corresponds to (e.g., includes) the audio stream manager 130. Components of the audio stream manager 130 are integrated in the vehicle 2102 and are illustrated using dashed lines to indicate internal components that are not generally visible to a user of the vehicle 2102. During operation, the audio stream manager 130 multi-streams audio data as a source device to a plurality of wearable audio devices.

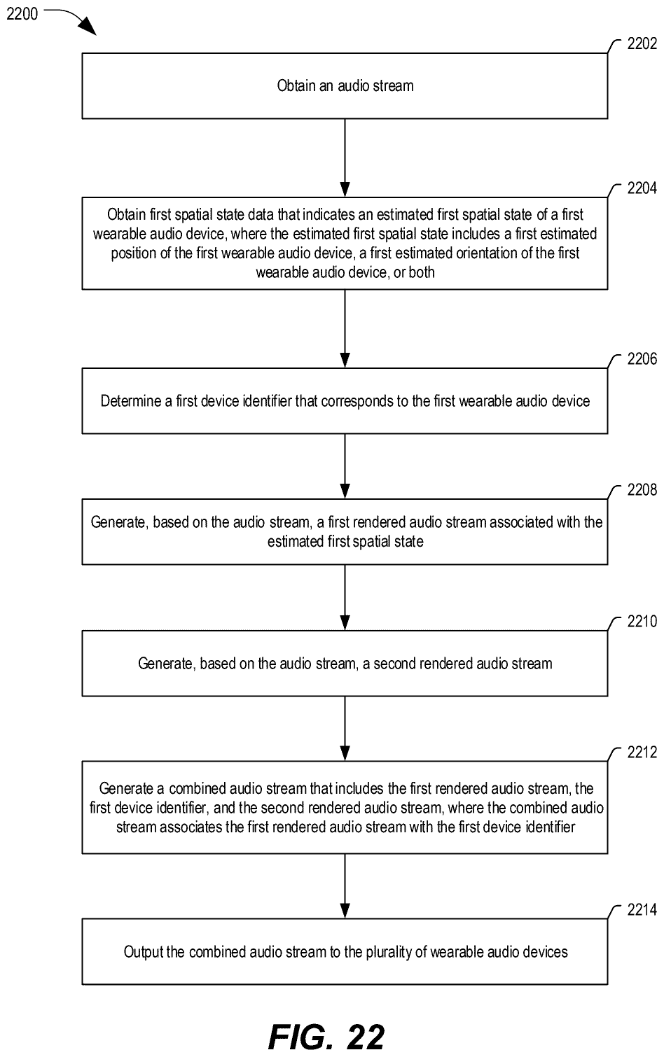

Referring to FIG. 22, a particular embodiment of a method 2200 of multi-streaming audio to a plurality of wearable audio devices is shown. In a particular aspect, one or more operations of the method 2200 are performed by at least one of the audio stream manager 130, the one or more processors 118, the source device 102, the system 100 of FIG. 1, the user detector 202, the user identifier mapper 204, the user-to-device mapper 206, the HRTF mapper 208, the HPTF mapper 210, the user tracker 212, the spatial renderer 214, the audio data packer 216, the output device 218 of FIG. 2, the device detector 302, the device identifier mapper 304, the device tracker 306, the spatial renderer 308, the audio data packer 310, the output device 312 of FIG. 3, the one or more processors 1190 of FIG. 11, or a combination thereof.

The method 2200 includes, at block 2202, obtaining an audio stream. For example, the audio stream manager 130 of FIG. 1 obtains the audio stream 114 to generate the combined audio stream 112 corresponding to a plurality of wearable audio devices including the wearable audio device 104 of FIG. 1 and the wearable audio device 108 of FIG. 1, as described with reference to FIGS. 1-3.

The method 2200 includes, at block 2204, obtaining first spatial state data that indicates an estimated first spatial state of a first wearable audio device, where the estimated first spatial state includes a first estimated position of the first wearable audio device, a first estimated orientation of the first wearable audio device, or both. For example, the audio stream manager 130 obtains the spatial state data 232 or the spatial state data 326 that indicates an estimated spatial state of the wearable audio device 104, as described with reference to FIG. 2 or 3.

The method 2200 includes, at block 2206, determining a first device identifier that corresponds to the first wearable audio device. For example, the audio stream manager 130 determines the device identifier 224 or the device identifier 322, as described with reference to FIG. 2 or 3.

The method 2200 includes, at block 2208, generating, based on the audio stream, a first rendered audio stream associated with the estimated first spatial state. For example, the audio stream manager 130 generates the rendered audio stream 234 or the rendered audio stream 328, as described with reference to FIG. 2 or 3.

The method 2200 includes, at block 2210, generating, based on the audio stream, a second rendered audio stream. For example, the audio stream manager 130 generates the rendered audio stream 236 or the rendered audio stream 330, as described with reference to FIG. 2 or 3.

The method 2200 includes, at block 2212, generating a combined audio stream that includes the first rendered audio stream, the first device identifier, and the second rendered audio stream, where the combined audio stream associates the first rendered audio stream with the first device identifier. For example, the audio stream manager 130 generates the combined audio stream 112 that includes the rendered audio stream 234, the rendered audio stream 236, and the device identifier 224, as described with reference to FIG. 2. The combined audio stream 112 associates the device identifier 224 with the rendered audio stream 234. As another example, the audio stream manager 130 generates the combined audio stream 112 that includes the rendered audio stream 328, the rendered audio stream 330, and the device identifier 322, as described with reference to FIG. 3. The combined audio stream 112 associates the device identifier 322 with the rendered audio stream 328.

The method 2200 includes, at block 2212, outputting the combined audio stream to the plurality of wearable audio devices. For example, the audio stream manager 130 outputs the combined audio stream 112 to the wearable audio devices 104 and 108, as described with reference to FIGS. 1-3.

In some embodiments, generating the first rendered audio stream is based on a head-related transfer function (HRTF) of the first user, a head-phone transfer function (HPTF) of the first wearable audio device, or any combination thereof. For example, generating the first rendered audio stream is based on the HRTF 228, the HPTF 230, or any combination thereof, as described with reference to FIG. 2.

In some embodiments, the method 2200 includes detecting that a second user is using the first wearable audio device, and, based on detecting that the second user is using the first wearable audio device, associating the second user with the first device identifier. For example, the audio stream manager 130 associates the user 1002 of FIG. 10 with the wearable audio device 104 based on detecting that the user 1002 is using the wearable audio device 104, as described with reference to FIG. 10.

In some embodiments, determining the first device identifier includes analyzing an image of the first wearable audio device, as described with reference to FIG. 3. In some embodiments, the first device identifier includes a MAC address of the first wearable audio device, an IP address of the first wearable audio device, or both. In some embodiments, determining the first device identifier includes identifying a first user using the first wearable audio device and determining that the first user is associated with the first device identifier, as described with reference to FIG. 2.

In some embodiments, the method 2200 includes determining that the audio stream corresponds to a third wearable audio device, and based on determining that the third wearable audio device is not configured to process the combined audio stream, outputting a third rendered audio stream to the third wearable audio device using a communication link to the third wearable audio device, wherein the communication link is formed using an IP address of the third wearable audio device. For example, the audio stream manager 130 determines that the wearable audio device 902 is not configured to process the combined audio stream 112 and outputs the audio stream 910 to the wearable audio device 902, as described with reference to FIG. 9.

In some embodiments, the method 2200 includes generating, based on the audio stream, the third rendered audio stream, where the third rendered audio stream is associated with an estimated third spatial state of the third wearable audio device, and where the third rendered audio stream is not included in the combined audio stream. For example, the audio stream manager 130 generates the audio stream 910 including a rendered audio stream corresponding to the wearable audio device 902, as described with reference to FIG. 9.

A technical advantage of the method 2200 thus includes enabling multi-streaming audio to a plurality of wearable audio devices using a single combined audio stream.

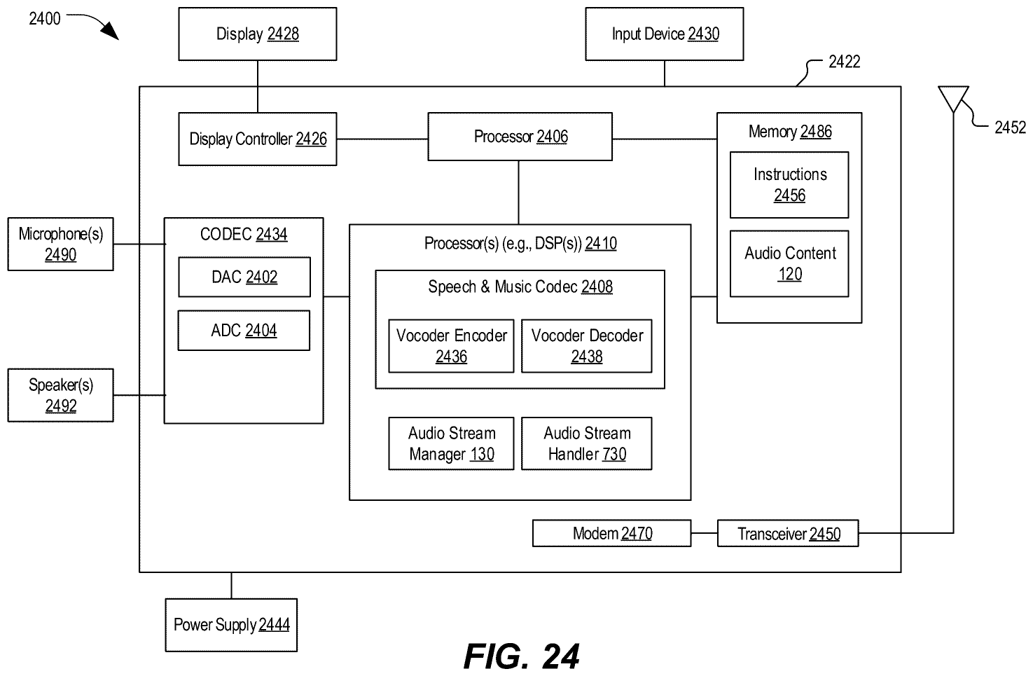

The method 2200 of FIG. 22 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 2200 of FIG. 22 may be performed by a processor that executes instructions, such as described with reference to FIG. 24.

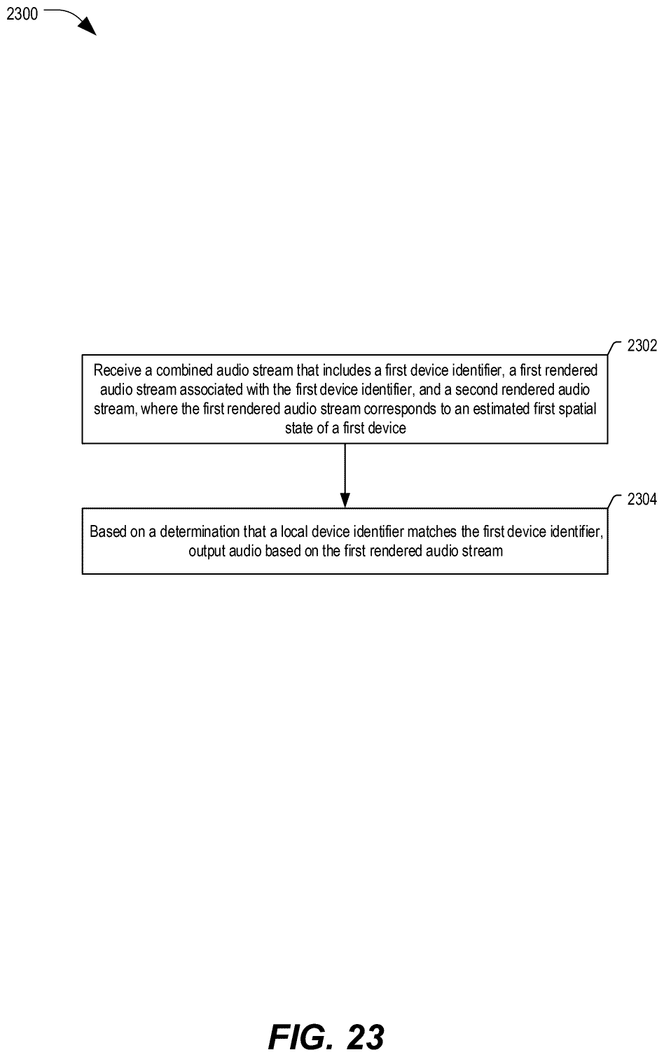

Referring to FIG. 23, a particular embodiment of a method 2300 of receiving and processing multi-stream audio is shown. In a particular aspect, one or more operations of the method 2300 are performed by at least one of the wearable audio device 104, the wearable audio device 108, the system 100 of FIG. 1, the audio stream handler 730, the one or more processors 708, the system 700 of FIG. 7, the one or more processors 1190 of FIG. 11, or a combination thereof.

The method 2300 includes, at block 2302, receiving a combined audio stream that includes a first device identifier, a first rendered audio stream associated with the first device identifier, and a second rendered audio stream, where the first rendered audio stream corresponds to an estimated first spatial state of a first device. For example, the audio stream handler 730 of FIG. 7 receives the combined audio stream 112 of FIG. 1 that includes the device identifier A 508 of FIG. 5 indicating a device identifier, the subpacket A 410 of FIG. 4 of a first rendered audio stream, and the subpacket B 412 of FIG. 4 of a second rendered audio stream, as described with reference to FIGS. 4, 5, and 7. As another example, the audio stream handler 730 of FIG. 7 receives the combined audio stream 112 of FIG. 1 that includes the device identifier AA 610 of FIG. 6 indicating a device identifier, the subpacket A 410 of FIG. 4 of a first rendered audio stream, and the subpacket N 414 of FIG. 4 of a second rendered audio stream, as described with reference to FIGS. 4, 6, and 7.

The method 2300 includes, at block 2304, based on a determination that a local device identifier matches the first device identifier, outputting audio based on the first rendered audio stream. For example, based on determining that the device identifier 712 matches the device identifier indicated in the device identifier A 508, the audio stream handler 730 outputs audio based on the subpacket A 410 of a first rendered audio stream, as described with reference to FIGS. 5 and 7. As another example, based on determining that the device identifier 712 matches the device identifier indicated in the device identifier AA 610, the audio stream handler 730 outputs audio based on the subpacket A 410 of a first rendered audio stream, as described with reference to FIGS. 6-7. In some embodiments, the method 2300 includes, based on a determination that the local device identifier matches a second device identifier included in the combined audio stream and associated with the second rendered audio stream, outputting audio based on the second rendered audio stream. For example, based on determining that the device identifier 712 matches a second device identifier indicated in the device identifier N 516, the audio stream handler 730 outputs audio based on the subpacket N 414 of a second rendered audio stream. As another example, based on determining that the device identifier 712 matches a second device identifier indicated in the device identifier NA 618, the audio stream handler 730 outputs audio based on the subpacket N 414 of a second rendered audio stream.

In some embodiments, the method 2300 includes, based on a determination that the local device identifier does not match the second device identifier, refraining from outputting audio based on the second rendered audio stream. For example, based on determining that the device identifier 712 does not match a second device identifier indicated in the device identifier N 516, the audio stream handler 730 refrains from outputting audio based on the subpacket N 414 of a second rendered audio stream. As another example, based on determining that the device identifier 712 does not match a second device identifier indicated in the device identifier NA 618, the audio stream handler 730 refrains from outputting audio based on the subpacket N 414 of a second rendered audio stream.

In some embodiments, the method 2300 includes, based on a determination that the local device identifier does not match the first device identifier and does not match the second device identifier, refraining from outputting audio based on the combined audio stream. For example, based on determining that the device identifier 712 does not match any device identifier indicated in the header 500 (or the header 600), the audio stream handler 730 refrains from outputting audio based on the combined audio stream 112 of the packet 400.

In some embodiments, the method 2300 includes, based on a determination that the local device identifier does not match the first device identifier, output audio based on the second rendered audio stream, wherein the second rendered audio stream is a default audio stream. For example, based on determining that the device identifier 712 does not match any device identifiers indicated by the device identifiers of the header 500 (or the header 600), the audio stream handler 730 outputs audio based on a subpacket (e.g., the subpacket N 414) of a default rendered audio stream that is indicated by a default offset value, as described with reference to FIGS. 4-6.

A technical advantage of the method 2300 thus enables receiving and processing multi-streamed audio.

The method 2300 of FIG. 23 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 2300 of FIG. 23 may be performed by a processor that executes instructions, such as described with reference to FIG. 24.

Referring to FIG. 24, a block diagram of a particular illustrative embodiment of a device 2400 is depicted. In various embodiments, the device 2400 may have more or fewer components than illustrated in FIG. 24. In an illustrative embodiment, the device 2400 may include the source device 102, the wearable audio device 104, or both. In an illustrative embodiment, the device 2400 may perform one or more operations described with reference to FIGS. 1-23.

In a particular embodiment, the device 2400 includes a processor 2406 (e.g., a CPU). The device 2400 may include one or more additional processors 2410 (e.g., one or more DSPs). In a particular aspect, the one or more processors 118 of FIG. 1, the one or more processors 708 of FIG. 7, the one or more processors 1190 of FIG. 11, or a combination thereof, correspond to the processor 2406, the processors 2410, or a combination thereof. The processors 2410 may include a speech and music coder-decoder (CODEC) 2408, the audio stream manager 130, the audio stream handler 730, or a combination thereof. The CODEC 2408 may include a voice coder (“vocoder”) encoder 2436 and a vocoder decoder 2438. In some embodiments, the CODEC 2408 includes one or more components of the audio stream manager 130, one or more components of the audio stream handler 730, or both.

The device 2400 may include a memory 2486 and a CODEC 2434. The memory 2486 may include instructions 2456, that are executable by the one or more additional processors 2410 (or the processor 2406) to implement the functionality described with reference to the audio stream manager 130, the audio stream handler 730, or both. The device 2400 may include a modem 2470 coupled, via a transceiver 2450, to an antenna 2452. The memory 2486 may further include data used or generated by one or more components of the source device 102, the wearable audio device 104, or both. For example, the memory 2486 may include the audio content 120 of FIG. 1 used to generate rendered audio content, the audio content 710 of FIG. 7 used to generate audio data, or both. In some embodiments, the memory 2486 corresponds to the memory 116 of FIG. 1, the memory 706 of FIG. 7, or both.

The device 2400 may include a display 2428 coupled to a display controller 2426. One or more speakers 2492, one or more microphone 2490, or a combination thereof may be coupled to the CODEC 2434. The CODEC 2434 may include a digital-to-analog converter (DAC) 2402, an analog-to-digital converter (ADC) 2404, or both. In a particular embodiment, the CODEC 2434 may receive analog signals from the one or more microphones 2490, convert the analog signals to digital signals using the ADC 2404, and provide the digital signals to the speech and music codec 2408. The speech and music codec 2408 may process the digital signals, and the digital signals may further be processed by the audio stream manager 130 to generate a combined audio stream 112. In a particular embodiment, the speech and music codec 2408 may provide digital signals (e.g., corresponding to a rendered audio stream that the audio stream handler 730 extracted from a combined audio stream 112) to the CODEC 2434. The CODEC 2434 may convert the digital signals to analog signals using the DAC 2402 and may provide the analog signals to the one or more speakers 2492.

In a particular embodiment, the device 2400 may be included in a system-in-package or system-on-chip device 2422. In a particular embodiment, the memory 2486, the processor 2406, the processors 2410, the display controller 2426, the CODEC 2434, and the modem 2470 are included in the system-in-package or system-on-chip device 2422. In a particular aspect, the modem 2470 is configured to receive an audio stream, transmit an audio stream, or both. In an example, the modem 2470 can receive an audio stream 114, transmit a combined audio stream 112, or both. In an example, the modem 2470 can transmit the combined audio stream 112, the audio stream 910, or both. In a particular embodiment, an input device 2430 and a power supply 2444 are coupled to the system-in-package or the system-on-chip device 2422. Moreover, in a particular embodiment, as illustrated in FIG. 24, the display 2428, the input device 2430, the one or more speakers 2492, the one or more microphones 2490, the antenna 2452, and the power supply 2444 are external to the system-in-package or the system-on-chip device 2422. In a particular embodiment, each of the display 2428, the input device 2430, the one or more speakers 2492, the one or more microphones 2490, the antenna 2452, and the power supply 2444 may be coupled to a component of the system-in-package or the system-on-chip device 2422, such as an interface or a controller.

The device 2400 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

### Particular Aspects of the Disclosure are Described Below in Sets of Interrelated Examples:

According to Example 1, a device includes a memory configured to store audio content; and one or more processors coupled to the memory, the one or more processors configured to obtain an audio stream; obtain first spatial state data that indicates an estimated first spatial state of a first wearable audio device of a plurality of wearable audio devices, wherein the estimated first spatial state includes a first estimated position of the first wearable audio device, a first estimated orientation of the first wearable audio device, or both; determine a first device identifier that corresponds to the first wearable audio device; generate, based on the audio stream, a first rendered audio stream associated with the estimated first spatial state; generate, based on the audio stream, a second rendered audio stream; generate a combined audio stream corresponding to the plurality of wearable audio devices, wherein the combined audio stream includes the first rendered audio stream, the first device identifier, and the second rendered audio stream, and wherein the combined audio stream associates the first rendered audio stream with the first device identifier; and output the combined audio stream to the plurality of wearable audio devices.
Example 2 includes the device of Example 1, wherein the one or more processors are configured to obtain second spatial state data that indicates an estimated second spatial state of a second wearable audio device of the plurality of wearable audio devices, wherein the estimated second spatial state includes a second estimated position of the second wearable audio device, a second estimated orientation of the second wearable audio device, or both; and determine a second device identifier that corresponds to the second wearable audio device, wherein the second rendered audio stream is associated with the estimated second spatial state, wherein the combined audio stream includes the second device identifier, and wherein the combined audio stream associates the second rendered audio stream with the second device identifier.
Example 3 includes the device of Example 1 or Example 2, wherein, to generate the combined audio stream, the one or more processors are configured to generate a plurality of packets of the combined audio stream, wherein a packet of the plurality of packets includes a header and a plurality of subpackets, wherein the plurality of subpackets includes at least a first subpacket of the first rendered audio stream and at least a second subpacket of the second rendered audio stream, and wherein the header indicates a count of the plurality of subpackets and a first group of one or more device identifiers, including the first device identifier, associated with the first subpacket.
Example 4 includes the device of Example 3, wherein the header includes a second group of one or more device identifiers associated with the second subpacket.
Example 5 includes the device of Example 3 or Example 4, wherein the first group includes a plurality of device identifiers associated with the first subpacket, and wherein the header indicates a count of the plurality of device identifiers associated with the first subpacket.
Example 6 includes the device of any of Examples 1 to 5, wherein the one or more processors are configured to obtain third spatial state data that indicates an estimated third spatial state of a third wearable audio device of the plurality of wearable audio devices, wherein the estimated third spatial state includes a third estimated position of the third wearable audio device, a third estimated orientation of the third wearable audio device, or both; determine a third device identifier that corresponds to the third wearable audio device; and based on a determination that the estimated first spatial state matches the estimated third spatial state, associate the first rendered audio stream with the third device identifier, wherein the combined audio stream includes the third device identifier.
Example 7 includes the device of any of Examples 1 to 6, wherein the first spatial state data includes six degrees of freedom (DoF) tracking data of a user.
Example 8 includes the device of any of Examples 1 to 7, wherein the one or more processors are configured to output the combined audio stream using a Bluetooth radio system or a wireless fidelity (Wi-Fi) audio system.
Example 9 includes the device of any of Examples 1 to 8, and further includes a modem coupled to the one or more processors, the modem configured to transmit the combined audio stream to the plurality of wearable audio devices.
Example 10 includes the device of any of Examples 1 to 9, wherein the one or more processors are integrated in a headset device, wherein the headset device is configured, when worn by a user, to output the combined audio stream to the plurality of wearable audio devices.
Example 11 includes the device of any of Examples 1 to 10, wherein the one or more processors are integrated in at least one of a mobile phone, a tablet computer device, a wearable electronic device, a camera device, a virtual reality headset, a mixed reality headset, or an augmented reality headset.
Example 12 includes the device of any of Examples 1 to 11, wherein the one or more processors are integrated in a vehicle, and wherein the vehicle is configured to output the combined audio stream to the plurality of wearable audio devices.
Example 13 includes the device of any of Examples 1 to 12, wherein the one or more processors are included in an integrated circuit.
According to Example 14, a method includes obtaining, at one or more processors, an audio stream; obtaining, at the one or more processors, first spatial state data that indicates an estimated first spatial state of a first wearable audio device of a plurality of wearable audio devices, wherein the estimated first spatial state includes a first estimated position of the first wearable audio device, a first estimated orientation of the first wearable audio device, or both; determining, at the one or more processors, a first device identifier that corresponds to the first wearable audio device; generating, based on the audio stream, a first rendered audio stream associated with the estimated first spatial state; generating, based on the audio stream, a second rendered audio stream; generating a combined audio stream corresponding to the plurality of wearable audio devices, wherein the combined audio stream includes the first rendered audio stream, the first device identifier, and the second rendered audio stream, and wherein the combined audio stream associates the first rendered audio stream with the first device identifier; and outputting the combined audio stream to the plurality of wearable audio devices.
Example 15 includes the method of Example 14, wherein determining the first device identifier that corresponds to the first wearable audio device comprises: identifying a first user using the first wearable audio device; and determining that the first user is associated with the first device identifier.
Example 16 includes the method of Example 15, wherein generating the first rendered audio stream is based on a head-related transfer function (HRTF) of the first user, a head-phone transfer function (HPTF) of the first wearable audio device, or any combination thereof.
Example 17 includes the method of Example 15, further including detecting that a second user is using the first wearable audio device; and based on detecting that the second user is using the first wearable audio device, associating the second user with the first device identifier.
Example 18 includes the method of any of Examples 14 to 17, wherein determining the first device identifier comprises analyzing an image of the first wearable audio device.
Example 19 includes the method of any of Examples 14 to 18, wherein the first device identifier includes a media access control (MAC) address of the first wearable audio device, an internet protocol (IP) address of the first wearable audio device, or both.
Example 20 includes the method of any of Examples 14 to 19, further including determining that the audio stream corresponds to a third wearable audio device; and based on determining that the third wearable audio device is not configured to process the combined audio stream, outputting a third rendered audio stream to the third wearable audio device using a communication link to the third wearable audio device, wherein the communication link is formed using an internet protocol (IP) address of the third wearable audio device.
Example 21 includes the method of Example 20, further including generating, based on the audio stream, the third rendered audio stream, wherein the third rendered audio stream is associated with an estimated third spatial state of the third wearable audio device, and wherein the third rendered audio stream is not included in the combined audio stream.
According to Example 22, a device includes a memory configured to store audio content; and one or more processors coupled to the memory, the one or more processors configured to receive a combined audio stream, includes a first device identifier; a first rendered audio stream associated with the first device identifier, wherein the first rendered audio stream corresponds to an estimated first spatial state of a first device; and a second rendered audio stream; and based on a determination that a local device identifier matches the first device identifier, output audio based on the first rendered audio stream.
Example 23 includes the device of Example 22, wherein the one or more processors are configured to, based on a determination that the local device identifier matches a second device identifier included in the combined audio stream and associated with the second rendered audio stream, output audio based on the second rendered audio stream.
Example 24 includes the device of Example 23, wherein the one or more processors are configured to, based on a determination that the local device identifier does not match the second device identifier, refrain from outputting audio based on the second rendered audio stream.
Example 25 includes the device of Example 24, wherein the one or more processors are configured to, based on a determination that the local device identifier does not match the first device identifier and does not match the second device identifier, refrain from outputting audio based on the combined audio stream.
Example 26 includes the device of Example 25, wherein the one or more processors are configured to, based on a determination that the local device identifier does not match the first device identifier, output audio based on the second rendered audio stream, wherein the second rendered audio stream is a default audio stream.
Example 27 includes the device of any of Examples 22 to 26, further including a modem coupled to the one or more processors, the modem configured to receive the combined audio stream.
Example 28 includes the device of any of Examples 22 to 27, wherein the one or more processors are integrated in a headset device, wherein the headset device is configured, when worn by a user, to receive the combined audio stream.
Example 29 includes the device of any of Examples 22 to 28, wherein the one or more processors are integrated in at least one of a mobile phone, a tablet computer device, a wearable electronic device, a camera device, a virtual reality headset, a mixed reality headset, or an augmented reality headset.
Example 30 includes the device of any of Examples 22 to 29, wherein the one or more processors are included in an integrated circuit.
According to Example 31, a method includes receiving a combined audio stream that includes a first device identifier, a first rendered audio stream associated with the first device identifier, and a second rendered audio stream, wherein the first rendered audio stream corresponds to an estimated first spatial state of a first device; and based on a determination that a local device identifier matches the first device identifier, outputting audio based on the first rendered audio stream.
Example 32 includes the method of Example 31, wherein the first device identifier includes a media access control (MAC) address of the first device, an internet protocol (IP) address of the first device, or both.
Example 33 includes the method of Example 31 or Example 32, further including based on a determination that the local device identifier does not match the second device identifier, refraining from outputting audio based on the second rendered audio stream.
According to Example 34, a method includes receiving a combined audio stream that includes a first device identifier, a first rendered audio stream associated with the first device identifier, and a second rendered audio stream, wherein the first rendered audio stream corresponds to an estimated first spatial state of a first device; and based on a determination that a local device identifier does not match the first device identifier, outputting audio based on the second rendered audio stream.
Example 35 includes the method of Example 34, wherein the first device identifier includes a media access control (MAC) address of the first device, an internet protocol (IP) address of the first device, or both.
Example 36 includes the method of Example 34 or Example 35, wherein outputting the audio is based on a determination that the local device identifier matches a second device identifier included in the combined audio stream and associated with the second rendered audio stream.
Example 37 includes the method of any of Examples 34 to 36, wherein the second rendered audio stream is a default audio stream.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such embodiment decisions are not to be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store audio content; and
one or more processors coupled to the memory, the one or more processors configured to:
obtain an audio stream;
obtain first spatial state data that indicates an estimated first spatial state of a first wearable audio device of a plurality of wearable audio devices, wherein the estimated first spatial state includes a first estimated position of the first wearable audio device, a first estimated orientation of the first wearable audio device, or both;
determine a first device identifier that corresponds to the first wearable audio device;
generate, based on the audio stream, a first rendered audio stream associated with the estimated first spatial state;
generate, based on the audio stream, a second rendered audio stream;
generate a combined audio stream corresponding to the plurality of wearable audio devices, wherein the combined audio stream includes the first rendered audio stream, the first device identifier, and the second rendered audio stream, and wherein the combined audio stream associates the first rendered audio stream with the first device identifier; and
output the combined audio stream to the plurality of wearable audio devices.

2. The device of claim 1, wherein the one or more processors are configured to:
obtain second spatial state data that indicates an estimated second spatial state of a second wearable audio device of the plurality of wearable audio devices, wherein the estimated second spatial state includes a second estimated position of the second wearable audio device, a second estimated orientation of the second wearable audio device, or both; and
determine a second device identifier that corresponds to the second wearable audio device,
wherein the second rendered audio stream is associated with the estimated second spatial state,
wherein the combined audio stream includes the second device identifier, and
wherein the combined audio stream associates the second rendered audio stream with the second device identifier.

3. The device of claim 1,
wherein, to generate the combined audio stream, the one or more processors are configured to generate a plurality of packets of the combined audio stream,
wherein a packet of the plurality of packets includes a header and a plurality of subpackets,
wherein the plurality of subpackets includes at least a first subpacket of the first rendered audio stream and at least a second subpacket of the second rendered audio stream, and
wherein the header indicates a count of the plurality of subpackets and a first group of one or more device identifiers, including the first device identifier, associated with the first subpacket.

4. The device of claim 3, wherein the header includes a second group of one or more device identifiers associated with the second subpacket.

5. The device of claim 3,
wherein the first group includes a plurality of device identifiers associated with the first subpacket, and
wherein the header indicates a count of the plurality of device identifiers associated with the first subpacket.

6. The device of claim 1, wherein the one or more processors are configured to:
obtain third spatial state data that indicates an estimated third spatial state of a third wearable audio device of the plurality of wearable audio devices, wherein the estimated third spatial state includes a third estimated position of the third wearable audio device, a third estimated orientation of the third wearable audio device, or both;
determine a third device identifier that corresponds to the third wearable audio device; and
based on a determination that the estimated first spatial state matches the estimated third spatial state, associate the first rendered audio stream with the third device identifier,
wherein the combined audio stream includes the third device identifier.

7. The device of claim 1, wherein the first spatial state data includes six degrees of freedom (DoF) tracking data of a user.

8. The device of claim 1, wherein the one or more processors are configured to output the combined audio stream using a Bluetooth radio system or a wireless fidelity (Wi-Fi) audio system.

9. The device of claim 1, further comprising a modem coupled to the one or more processors, the modem configured to transmit the combined audio stream to the plurality of wearable audio devices.

10. The device of claim 1, wherein the one or more processors are integrated in a headset device, wherein the headset device is configured, when worn by a user, to output the combined audio stream to the plurality of wearable audio devices.

11. The device of claim 1, wherein the one or more processors are integrated in at least one of a mobile phone, a tablet computer device, a wearable electronic device, a camera device, a virtual reality headset, a mixed reality headset, or an augmented reality headset.

12. The device of claim 1, wherein the one or more processors are integrated in a vehicle, and wherein the vehicle is configured to output the combined audio stream to the plurality of wearable audio devices.

13. The device of claim 1, wherein the one or more processors are included in an integrated circuit.

14. A method comprising:
obtaining, at one or more processors, an audio stream;
obtaining, at the one or more processors, first spatial state data that indicates an estimated first spatial state of a first wearable audio device of a plurality of wearable audio devices, wherein the estimated first spatial state includes a first estimated position of the first wearable audio device, a first estimated orientation of the first wearable audio device, or both;
determining, at the one or more processors, a first device identifier that corresponds to the first wearable audio device;
generating, based on the audio stream, a first rendered audio stream associated with the estimated first spatial state;
generating, based on the audio stream, a second rendered audio stream;
generating a combined audio stream corresponding to the plurality of wearable audio devices, wherein the combined audio stream includes the first rendered audio stream, the first device identifier, and the second rendered audio stream, and wherein the combined audio stream associates the first rendered audio stream with the first device identifier; and
outputting the combined audio stream to the plurality of wearable audio devices.

15. The method of claim 14, wherein determining the first device identifier that corresponds to the first wearable audio device comprises:
identifying a first user using the first wearable audio device; and
determining that the first user is associated with the first device identifier.

16. The method of claim 15, wherein generating the first rendered audio stream is based on a head-related transfer function (HRTF) of the first user, a head-phone transfer function (HPTF) of the first wearable audio device, or any combination thereof.

17. The method of claim 15, further comprising:
detecting that a second user is using the first wearable audio device; and
based on detecting that the second user is using the first wearable audio device, associating the second user with the first device identifier.

18. The method of claim 14, wherein determining the first device identifier comprises analyzing an image of the first wearable audio device.

19. The method of claim 14, wherein the first device identifier includes a media access control (MAC) address of the first wearable audio device, an internet protocol (IP) address of the first wearable audio device, or both.

20. The method of claim 14, further comprising:
determining that the audio stream corresponds to a third wearable audio device; and
based on determining that the third wearable audio device is not configured to process the combined audio stream, outputting a third rendered audio stream to the third wearable audio device using a communication link to the third wearable audio device, wherein the communication link is formed using an internet protocol (IP) address of the third wearable audio device.

21. The method of claim 20, further comprising:
generating, based on the audio stream, the third rendered audio stream,
wherein the third rendered audio stream is associated with an estimated third spatial state of the third wearable audio device, and
wherein the third rendered audio stream is not included in the combined audio stream.

22. A device comprising:
a memory configured to store audio content; and
one or more processors coupled to the memory, the one or more processors configured to:
receive a combined audio stream, comprising:
a first device identifier;
a first rendered audio stream associated with the first device identifier, wherein the first rendered audio stream corresponds to an estimated first spatial state of a first device; and
a second rendered audio stream; and
based on a determination that a local device identifier matches the first device identifier, output audio based on the first rendered audio stream.

23. The device of claim 22, wherein the one or more processors are configured to, based on a determination that the local device identifier matches a second device identifier included in the combined audio stream and associated with the second rendered audio stream, output audio based on the second rendered audio stream.

24. The device of claim 23, wherein the one or more processors are configured to, based on a determination that the local device identifier does not match the second device identifier, refrain from outputting audio based on the second rendered audio stream.

25. The device of claim 24, wherein the one or more processors are configured to, based on a determination that the local device identifier does not match the first device identifier and does not match the second device identifier, refrain from outputting audio based on the combined audio stream.

26. The device of claim 25, wherein the one or more processors are configured to, based on a determination that the local device identifier does not match the first device identifier, output audio based on the second rendered audio stream, wherein the second rendered audio stream is a default audio stream.

27. The device of claim 22, further comprising a modem coupled to the one or more processors, the modem configured to receive the combined audio stream.

28. The device of claim 22, wherein the one or more processors are integrated in a headset device, wherein the headset device is configured, when worn by a user, to receive the combined audio stream.

29. The device of claim 22, wherein the one or more processors are integrated in at least one of a mobile phone, a tablet computer device, a wearable electronic device, a camera device, a virtual reality headset, a mixed reality headset, or an augmented reality headset.

30. The device of claim 22, wherein the one or more processors are included in an integrated circuit.
